(19) United States
(12) Patent Application Publication
(10) Pub. No.: US 2020/0324523 A1
(43) Pub. Date: Oct. 15, 2020

(54) PACKAGING MATERIAL AND METHOD OF USING THE SAME

(71) Applicant: FUJIFILM Corporation, Tokyo (JP)

(72) Inventors: Akihiro IKEYAMA, Kanagawa (JP); Shogo KATANO, Kanagawa (JP)

(73) Assignee: FUJIFILM Corporation, Tokyo (JP)

(21) Appl. No.: 16/911,835

(22) Filed: Jun. 25, 2020

Related U.S. Application Data
(63) Continuation of application No. PCT/JP2018/041124, filed on Nov. 6, 2018.

(30) Foreign Application Priority Data
Dec. 27, 2017 (JP) 2017-251539

(51) Int. Cl. B32B 23/08; B65D 65/40; B32B 7/12

(52) U.S. Cl. CPC B32B 23/08; B32B 2439/70; B32B 7/12; B65D 65/40

(57) ABSTRACT

The packaging material is formed of a laminated film having a base material containing cellulose acylate and a resin layer. The resin layer is formed on one surface of the base material and contains any one of a mixture of an acrylic resin and a cellulose derivative, a silicone elastomer, or a urethane elastomer. The packaging material is formed of the laminated film having a moisture permeability at 40° C. and a relative humidity of 90% in a range of 60 g/m²·day or more and 700 g/m²·day or less.

### CROSS-REFERENCE TO RELATED APPLICATIONS

This application is a Continuation of PCT International Application No. PCT/JP2018/041124 filed on 6 Nov. 2018, which claims priority under 35 U.S.C § 119(a) to Japanese Patent Application No. 2017-251539 filed on 27 Dec. 2017. The above application is hereby expressly incorporated by reference, in its entirety, into the present application.

### BACKGROUND OF THE INVENTION

### 1. Field of the Invention

The present invention relates to a packaging material and a method of using the same.

### 2. Description of the Related Art

In a case of storing plants such as fruits and vegetables, it is important to prevent a freshness from decreasing. For example, in order to prevent deterioration and drying of the fruits and vegetables due to respiration, packaging is performed using a packaging material. In a case where fruits and vegetables are packaged by a packaging material, drying of the fruits and vegetables can be prevented. On the other hand, particularly in a case where fruits and vegetables are packaged in a sealed state, there are problems that dew condensation occurs inside a packaging material to cause mold on the fruits and vegetables, and color changes due to adhesion of moisture to the fruits and vegetables. Therefore, it is preferable that dew condensation does not occur, which is particularly necessary for long-time storage.

As a method of packaging fruits and vegetables to enable long-time storage without causing dew condensation inside the packaging material, modified atmosphere (MA) packaging, anti-fogging packaging that prevents dew condensation inside the packaging material, and the like are used. For example, as the MA packaging, a packaging film that is an oxygen barrier-moisture permeable laminated film formed of a base material having an oxygen barrier property and a moisture permeability, an anchor coat layer, and a thermoplastic resin layer formed in a stripe shape is disclosed (JP2011-006084A). As the base material having an oxygen barrier property and a moisture permeability, a polyamide film or a film obtained by sticking the polyamide film to another film is used. It is disclosed that the packaging film has not only an oxygen barrier property but also a moisture permeability of 100 g/m²·MPa·day or more in conformity to Japanese Industrial Standard JIS K-0208, so that extra water vapor can be released to an outside even in a sealed state, an oxygen barrier property is high, and a content can be stored for a long time by preventing oxidative deterioration of the content.

As a material whose moisture permeability is controlled using a film which is made of a resin such as cellulose triacetate and has a moisture permeability, a laminated film as an optical film having a film made of a resin such as cellulose triacetate as a base material film and a layer formed of a specific curable composition is disclosed (WO2014/119487A (corresponding to US2015/0331151A1)). It is disclosed that this film is an optical film having a reduced moisture permeability.

### SUMMARY OF THE INVENTION

Since the film of JP2011-006084A has a moisture permeability and is formed of polyamide, there is a concern that dew condensation is not sufficiently prevented. In addition, due to the moisture permeability as described above, after storage for one week, the moisture of the content is released to the outside fast, and a surface of the content may be too dry (see JP2011-006084A and Example 3). Thus, prevention of drying of the content is not sufficient. Therefore, in a case where fruits and vegetables are packaged using this packaging material and stored for a long time, there is a concern that the fruits and vegetables are dried out and cannot be stored while maintaining a freshness thereof. In addition, the film is formed of polyamide, and thus, in a case where the content is packaged to exhibit a moisture permeability, there is a concern that the moisture absorbed by polyamide causes deformation such as elongation in the packaging material.

The film of WO2014/119487A is a film used as an optical film, and in a case where the film is processed into a bag shape or a box shape as a packaging material for fruits and vegetables, there is a concern that a crack or the like occurs in a folded portion. In many cases, the packaging material is used in such a manner that the content is put in the packaging material processed into a shape such as a bag or a box and then sealed, and in order to sufficiently exhibit an effect of adjusting a humidity in a space inside a package, it is necessary that the folded portion of the packaging material is not cracked or damaged. In a case where the package is stored for a long time, it is preferable that deformation such as elongation or wrinkles does not occur in the packaging material due to a humidity or the like during long-time storage. As described above, further improvement is required for the packaging material for fruits and vegetables. In the present specification, the term “package” means a combination of an article or the like to be stored and a packaging material such as a packaging bag, and the term “packaging material” means a packaging material itself such as a packaging bag.

An object of the present invention is to provide a packaging material which does not cause dew condensation inside the packaging material and suppresses drying of an object to be packaged even though a package in which fruits and vegetables are packaged in a sealed state is refrigerated and stored for a long time, and a method of using the same.

In order to solve the above problems, a packaging material of an embodiment of the present invention is a packaging material comprising a laminated film, in which the laminated film contains a base material and a resin layer formed on one surface of the base material and has a moisture permeability at 40° C. and a relative humidity of 90% in a range of 60 g/m²·day or more and 700 g/m²·day or less. The base material contains cellulose acylate. The resin layer contains any one of a composition including an acrylic resin and a cellulose derivative, a silicone elastomer, or a urethane elastomer.

It is preferable that the resin layer has a moisture permeation resistance per 1 μm of a thickness calculated from a moisture permeability at 40° C. and a relative humidity of 90% in a range of 3.0×10⁻⁵ (m²·day/g)/μm or more and 7.5×10⁻⁴ (m²·day/g)/μm or less.

It is preferable that the laminated film contains a saponified layer formed on the other surface of the base material opposite to the one surface, and the saponified layer contains a saponified cellulose acylate.

It is preferable that the base material contains any one of an ester derivative of a monosaccharide, an ester derivative of a polysaccharide, an ester oligomer, or an acrylic polymer.

It is preferable that the laminated film has a thickness in a range of 10 μm to 100 μm.

It is preferable that the packaging material has a bag shape in which the resin layer is disposed outside. Further, it is preferable that the packaging material has a box shape in which the resin layer is disposed outside. Further, it is preferable that the packaging material has a cylindrical shape in which the resin layer is disposed outside. Further, it is preferable that the packaging material has a folded portion of the laminated film.

It is preferable that the packaging material packages a plant. Further, it is preferable that the packaging material packages fruits and vegetables. Further, it is preferable that the packaging material packages a food.

In the method of using the packaging material of the embodiment of the present invention, it is preferable that an object to be packaged is packaged in a sealed state with the packaging material.

The packaging material of the embodiment of the present invention does not cause dew condensation inside the packaging material and suppresses drying of an object to be packaged even though a package in which fruits and vegetables are packaged in a sealed state is refrigerated and stored for a long time. According to the method of using the packaging material of the embodiment of the present invention, it is possible to store fruits and vegetables for a long time while maintaining a freshness.

### BRIEF DESCRIPTION OF THE DRAWINGS

FIG. 1 is a schematic cross-sectional view of a laminated film.

FIG. 2 is a schematic view of a packaging material having a bag shape.

FIG. 3 is a schematic view of a packaging material having a cylindrical shape.

FIG. 4 is a schematic view of a packaging material roll.

FIG. 5 is a schematic view of a packaging material having a box shape.

FIG. 6 is a schematic view of a laminated film forming apparatus.

FIG. 7 is a schematic view of sealed packaging.

FIG. 8 is a schematic cross-sectional view of a laminated film.

FIG. 9 is a schematic view of a laminated film forming apparatus.

### DESCRIPTION OF THE PREFERRED EMBODIMENTS

### First Embodiment

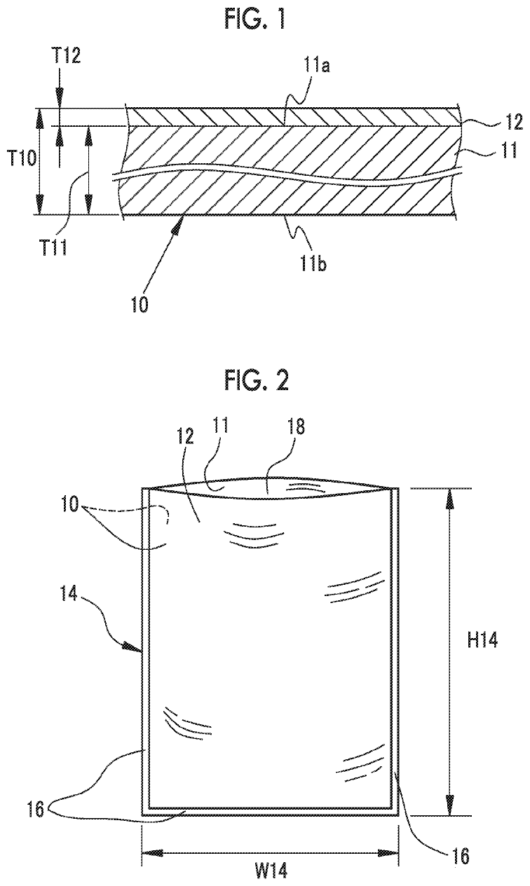

A packaging material of the embodiment of the present invention is formed of a laminated film. As shown in FIG. 1, a laminated film 10 has at least a base material 11 and a resin layer 12, and is formed in a film shape. The shape of the film is not limited, and may be a long shape or a sheet shape such as a rectangle shape. The laminated film 10 may further have the other layer.

The laminated film 10 has a moisture permeability determined in conformity to Japanese Industrial Standard JIS Z 0208, Condition B (40° C., a relative humidity of 90%) (hereinafter, a relative humidity is referred to as RH) in a range of 60 g/m²·day or more and 700 g/m²·day or less. More preferably, it is in a range of 90 g/m²·day or more and 550 g/m²·day or less, and still more preferably, it is in a range of 100 g/m²·day or more and 450 g/m²·day or less. In the present specification, a moisture permeability refers to a moisture permeability determined in conformity to Japanese Industrial Standard JIS Z 0208, Condition B (40° C., RH of 90%).

A thickness T10 of a whole of the laminated film 10 including the base material 11, the resin layer 12, and, in some cases, the other layer is preferably in a range of 10 μm to 120 μm. More preferably, it is in a range of 20 μm to 100 μm, and still more preferably, it is in a range of 30 μm to 80 μm.

The base material 11 is a base of the laminated film 10 and a support for supporting the resin layer 12. In a case where the other layer is provided in some cases, the base material functions as a support for supporting the other layer. A thickness T11 of the base material 11 is in a range of 10 μm to 100 μm, and preferably in a range of 20 μm to 80 μm. A moisture permeability of the base material 11 is preferably in a range of 300 g/m²·day or more and 2,000 g/m²·day or less.

In the present embodiment, the base material 11 contains cellulose acylate. Therefore, the base material 11 is formed of cellulose acylate. In the present embodiment, the cellulose acylate is cellulose triacetate (triacetylcellulose, hereinafter, referred to as TAC), but is not limited to TAC, and may be another cellulose acylate different from TAC. A moisture permeability of the base material 11 is in a range of 100 g/m²·day or more and 3,000 g/m²·day or less, preferably in a range of 200 g/m²·day or more and 2500 g/m²·day or less, and more preferably in a range of 300 g/m²·day or more and 2,000 g/m²·day or less.

Since the packaging material has the base material 11 containing cellulose acylate, appropriate water absorption and moisture release are performed by a temperature change and a humidity change according to an equilibrium moisture content of the cellulose acylate. That is, the equilibrium moisture content of the cellulose acylate contained in the base material 11 increases due to an increase in a humidity of an inner space of the packaging material due to the moisture released from an object to be packaged. Due to the increase in the equilibrium moisture content, the base material 11 absorbs the moisture. The humidity of the inner space of the packaging material decreases by the absorption of the moisture of the base material 11, and thus the equilibrium moisture content of the base material 11 is reduced and the moisture is released. The cellulose acylate contained in the base material 11 has an equilibrium moisture content having an appropriate moisture absorbing and releasing property, so that even though fruits and vegetables are packaged in a sealed state, the packaging material suppresses occurrence of dew condensation on an inner surface of the packaging material on the fruits and vegetables while maintaining an inside of the packaging material at a moderately high humidity such that drying of the fruits and vegetables is suppressed. Even though a temperature and/or a humidity of an external environment changes, the humidity change inside the packaging material is suppressed to be smaller than the change of the external environment. Moreover, an effect of suppressing the occurrence of dew condensation is obtained even during refrigerated storage, and lasts for a long time, for example, 14 days. As a result, the generation and growth of mold are also suppressed, and the fruits and vegetables are stored in a fresh state for a long time. Discoloration of the fruits and vegetables is suppressed by the environment maintained at the moderately high humidity and the suppression of dew condensation as described above.

The cellulose acylate has an acyl group since a hydroxy group of cellulose is esterified with a carboxylic acid. An acyl group substitution degree of the cellulose acylate contained in the base material 11 is preferably in a range of 2.00 to 2.97. In a case where the acyl group substitution degree is in the above range, deformation of the base material 11 due to water absorption by the increase in the humidity inside the packaging material is suppressed. The lower the acyl group substitution degree, the higher the amount of moisture absorbed by the cellulose acylate, so that deformation by water absorption is easily caused. For this reason, the acyl group substitution degree of the cellulose acylate contained in the base material 11 is preferably in a range of 2.00 or more. On the other hand, cellulose acylate having an acyl group substitution degree of more than 2.97 is not easily synthesized. Accordingly, the acyl group substitution degree is preferably 2.97 or less.

The acyl group substitution degree of the cellulose acylate contained in the base material 11 is more preferably in a range of 2.40 to 2.95, and still more preferably in a range of 2.70 to 2.95. As is well known, the acyl group substitution degree is a rate of esterification of the hydroxy group of cellulose with a carboxylic acid, that is, a degree of substitution of an acyl group.

The acyl group of the cellulose acylate constituting the base material 11 is not particularly limited, and may be an acetyl group having 1 carbon atom, or an acetyl group having 2 or more carbon atoms. The acyl group having 2 or more carbon atoms may be an aliphatic group or an aryl group. Examples thereof include an alkylcarbonyl ester, an alkenylcarbonyl ester, an aromatic carbonyl ester, or an aromatic alkylcarbonyl ester of cellulose, and each of these may further have a substituted group. Examples thereof include a propionyl group, a butanoyl group, a pentanoyl group, a hexanoyl group, an octanoyl group, a decanoyl group, a dodecanoyl group, a tridecanoyl group, a tetradecanoyl group, a hexadecanoyl group, an octadecanoyl group, an iso-butanoyl group, a t-butanoyl group, a cyclohexanecarbonyl group, an oleoyl group, a benzoyl group, a naphthylcarbonyl group, and a cinnamoyl group.

The cellulose acylate constituting the base material 11 may have only one type of acyl group or two or more types of acyl groups, and at least one type is preferably an acetyl group. In a case where the cellulose acylate has an acetyl group, the base material 11 easily absorbs moisture, and thus the effect of suppressing dew condensation or the like is further improved. Cellulose acylate in which all acyl groups are acetyl groups is most preferable, that is, the cellulose acylate is more preferably cellulose acetate.

The acyl group substitution degree can be obtained by a conventional method. For example, an acetylation degree (acetyl group substitution degree) is obtained through measurement and calculation of an acetylation degree according to ASTM: D-817-91 (method of testing cellulose acetate and the like). In addition, it can also be measured by a distribution measurement of an acylation degree (acyl group substitution degree) by high-performance liquid chromatography. As an example of this method, an acetylation degree of cellulose acetate is measured by dissolving a sample in methylene chloride, measuring a distribution of an acetylation degree by a linear gradient from a mixed liquid (mass ratio of methanol:water is 8:1) of methanol and water which is an eluent to a mixed liquid (mass ratio of dichloromethane:methanol is 9:1) of dichloromethane and methanol using a column Novapac-phenyl (manufactured by Waters Corporation), and comparing it with a calibration curve using a standard sample having a different acetylation degree. These measurement methods can be obtained with reference to methods disclosed in JP2003-201301A. In the measurement of an acetylation degree of cellulose acylate, in a case where the acetylation degree is obtained from the base material 11, high-performance liquid chromatography is preferably performed due to an additive contained in the base material.

A plasticizer is preferably added to cellulose acylate in order to form the base material 11. Various known plasticizers can be used as the plasticizer for cellulose acylate. Even with using of a plasticizer, dew condensation is suppressed, and discoloration of fruits and vegetables is also reliably suppressed. Preferred plasticizers include, for example, triphenyl acetate (TPP) and biphenyl diphenyl phosphate (BDP), and from a viewpoint of suppression of dew condensation and discoloration of fruits and vegetables, various plasticizers are used. Therefore, in a case where object to be packaged is a fruit or vegetable, various known plasticizers may be used as long as the safety is confirmed.

The base material 11 preferably contains any one of an ester derivative of sugar, an ester oligomer, or an acrylic polymer in addition to the cellulose acylate. The ester derivative of sugar and the ester oligomer function as a plasticizer for the cellulose acylate. By using the plasticizer, it is possible to adjust the moisture content of the cellulose acylate, and to improve the folding performance such that a folded portion is hardly damaged even in a folded state.

The ester derivative of sugar may be either an ester derivative of a monosaccharide or an ester derivative of a polysaccharide, and the base material 11 may contain both of them. In consideration of the viewpoint of safety in a case where the objects to be packaged are fruits and vegetables, examples of the sugar include monosaccharides such as glucose, galactose, mannose, fructose, xylose, and arabinose, and polysaccharides such as lactose, sucrose, nystose, 1F-fructosyl nystose, stachyose, maltitol, lactitol, lactulose, cellobiose, maltose, cellotriose, maltotriose, raffinose or kestose, gentiobiose, gentiotriose, gentiotetraose, xylotriose, and galactosyl sucrose. Glucose, fructose, sucrose, kestose, nystose, 1F-fructosyl nystose, stachyose, and the like are preferable, and sucrose and glucose are more preferable. Oligosaccharides can also be used as polysaccharides, and are manufactured by allowing enzymes such as amylase to act on starch, sucrose, or the like. Examples of the oligosaccharides include maltooligosaccharide, isomaltooligosaccharide, fructooligosaccharide, galactooligosaccharide, and xylooligosaccharide.

The monocarboxylic acid which is used for esterifying all or a part of the OH groups in the monosaccharide or polysaccharide structure is not particularly limited, and known aliphatic monocarboxylic acids, alicyclic monocarboxylic acids, aromatic monocarboxylic acids, and the like can be used. One type of carboxylic acid may be used, or two or more types thereof may be used.

Preferable examples of the aliphatic monocarboxylic acids include saturated fatty acids such as an acetic acid, a propionic acid, a butyric acid, an isobutyric acid, a valeric acid, a caproic acid, an enanthic acid, a caprylic acid, a pelargonic acid, a capric acid, a 2-ethyl-hexane carboxylic acid, an undecyl acid, a lauric acid, a tridecylic acid, a myristic acid, a pentadecylic acid, a palmitic acid, a heptadecylic acid, a stearic acid, a nonadecanoic acid, an arachic acid, a behenic acid, a lignoceric acid, a cerotic acid, a heptacosanoic acid, a montanic acid, a melissic acid, and a lacceric acid, unsaturated fatty acids such as an undecylenic acid, an oleic acid, a sorbic acid, a linoleic acid, a linolenic acid, an arachidonic acid, and an octenoic acid, and alicyclic monocarboxylic acids such as a cyclopentanecarboxylic acid, a cyclohexanecarboxylic acid, and a cyclooctanecarboxylic acid.

Preferable examples of the aromatic monocarboxylic acids include aromatic monocarboxylic acids such as a benzoic acid and a toluic acid in which an alkyl group or an alkoxy group is introduced to a benzene ring of a benzoic acid, aromatic monocarboxylic acids such as a cinnamic acid, a benzilic acid, a biphenylcarboxylic acid, a naphthalenecarboxylic acid, and a tetralincarboxylic acid which have two or more benzene rings, and derivatives thereof, and a benzoic acid and a naphthalenecarboxylic acid are particularly preferable.

In the present embodiment, an ester derivative of sucrose, more specifically, a benzoic acid ester (MONOPET (registered trademark) SB manufactured by DKS Co., Ltd.) is used as a sugar ester.

The ester oligomer is a compound having a repeating unit containing an ester bond of a dicarboxylic acid and a diol, and having a relatively low molecular weight of about several to 100 repeating units, and is preferably an aliphatic ester oligomer. This is because the action of the cellulose acylate as a plasticizer is more reliable than that of an aromatic ester oligomer.

The ester oligomer preferably has a molecular weight in a range of 500 to 10,000. The reason for this is that in a case where the molecular weight is 500 or more, the flexibility or heat sealability of the base material 11 is more improved than in a case where the molecular weight is less than 500, and in a case where the molecular weight is 10,000 or less, the compatibility with the cellulose acylate is more secured than in a case where the molecular weight is more than 10,000. The molecular weight of the ester oligomer is more preferably in a range of 700 to 5,000, and still more preferably in a range of 900 to 3,000.

The molecular weight of the ester oligomer has a molecular weight distribution, and thus it can be obtained by the weight-average molecular weight or the number-average molecular weight by gel permeation chromatography (GPC), the number-average molecular weight measurement method using terminal functional group amount measurement or osmotic pressure measurement, the viscosity average molecular weight using viscosity measurement, or the like. In the present embodiment, the number-average molecular weight measurement method using measurement of a hydroxyl group or an acid group of an ester as a terminal functional group is used.

In the ester oligomer, more preferably, the dicarboxylic acid has 2 to 10 carbon atoms, and the diol has 2 to 10 carbon atoms. In particular, both of the dicarboxylic acid and the diol are preferably aliphatic compounds. The reason for this is that using of an aliphatic dicarboxylic acid and an aliphatic diol can impart flexibility to the base material 11 and makes the moisture content more preferable. Examples of the dicarboxylic acid include aromatic carboxylic acids such as a phthalic acid, a terephthalic acid, and an isophthalic acid, and aliphatic carboxylic acids such as a malonic acid, a succinic acid, a glutaric acid, an adipic acid, a sebacic acid, an azelaic acid, a cyclohexanedicarboxylic acid, a maleic acid, and a fumaric acid. Examples of the aliphatic diol include ethanediol, 1,2-propanediol, 1,3-propanediol, 1,2-butanediol, 1,3-butanediol, 2-methyl-1,3-propanediol, 1,4-butanediol, 1,5-pentanediol, 2,2-dimethyl-1,3-propanediol (neopentyl glycol), 1,4-hexanediol, 1,4-cyclohexanediol, and 1,4-cyclohexanedimethanol. It is also preferable that the terminal hydroxyl group or the acid group of the ester oligomer is sealed with a monocarboxylic acid or a monoalcohol. Among these, an oligomer having an ester of an adipic acid and an ethylene glycol as a repeating unit, an oligomer having an ester of a succinic acid and an ethylene glycol as a repeating unit, and an oligomer having an ester of a terephthalic acid and an ethylene glycol and an ester of a phthalic acid and an ethylene glycol as a repeating unit are preferable.

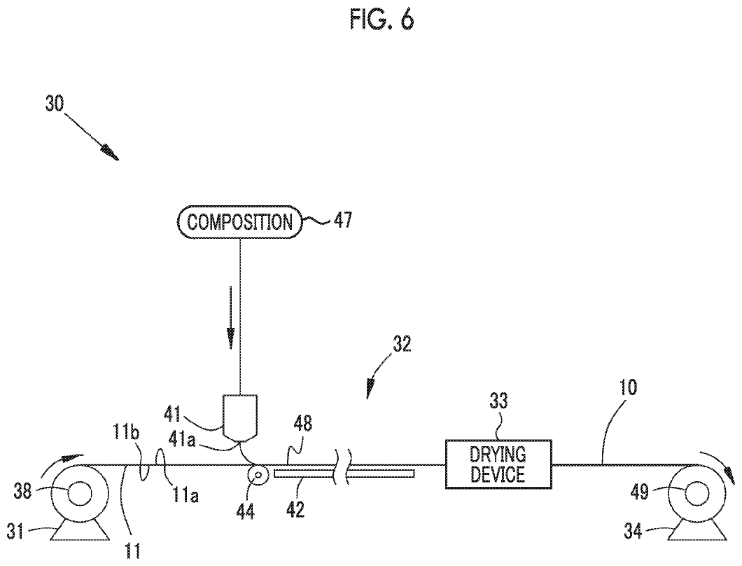

The mass of an ester derivative of a monosaccharide is denoted by M1, the mass of an ester derivative of a polysaccharide is denoted by M2, the mass of an ester oligomer is denoted by M3, and the sum of masses (hereinafter referred to as mass sum) obtained by M1+M2+M3 is denoted by MP. In a case where the base material 11 contains at least one of an ester derivative of a monosaccharide, an ester derivative of a polysaccharide, or an ester oligomer, the mass sum MP is preferably in a range of 5 to 30 under assumption that the mass of the cellulose acylate is 100. In a case where the mass sum MP is 5 or more, the flexibility of the base material 11 is better and/or the laminated film 10 obtained by a laminated film manufacturing apparatus 30 (see FIG. 6) is more easily formed than in a case where the mass sum MP is less than 5. In a case where the mass sum MP is 30 or less, the moisture content of the base material 11 becomes more preferable than in a case where the mass sum MP is more than 30.

The base material 11 may contain, as an additive, an ultraviolet absorber or fine particles as a so-called matting agent for preventing sticking between the base materials 11, in addition to the plasticizer. In a case where the material to be packaged is a fruit or vegetable, the additive preferably include those whose safety has been confirmed. By adjusting the type and the amount of the additive, the moisture content of the base material 11 can be adjusted, and as a result, the inner humidity is adjusted during packaging of objects to be packaged, for example, fruits and vegetables with the base material 11, can be adjusted, and thus drying of the objects to be packaged can be suppressed.

The acrylic polymer (acrylic resin) functions as an adjuster for the moisture content and/or the flexibility of the base material 11. As the acrylic polymer, for example, methyl acrylate, methyl methacrylate, and copolymers thereof with an acrylic acid or a methacrylic acid are preferable. In a case where the base material 11 contains an acrylic polymer, the mass of the acrylic polymer is preferably in a range of 10 to 300 under assumption that the mass of the cellulose acylate is 100.

The safety of esters of sugars, ester oligomers, and acrylic polymers are disclosed in the following documents. That is, regarding esters of sugars, descriptions are provided in journal of Synthetic Organic Chemistry, Vol. 21 (1963) No. 1, pages 19 to 27, catalog of DKS Co., Ltd., JP2011-237764A, and the like. In the catalog of DKS Co., Ltd., fatty acid esters and benzoic acid esters of sugars are disclosed. Regarding ester oligomers, descriptions including suppression of movement of an ester oligomer, as an additive for vinyl chloride, to the vinyl chloride are provided in the homepage of Vinyl Environmental Council, documents of the Japan Plasticizer Industry Association, and the like. Further, descriptions including blending with cellulose triacetate are provided in JP2009-173740A. Regarding acrylic polymers, descriptions are provided in JP2003-012859A and JP2011-154360A. The safety includes not only the safety of the substances itself, but also the safety of the decomposition products of the substances.

In the present embodiment, the base material 11 is formed as a long film. As described above, the dope is prepared from the material constituting the base material 11 and, as necessary, other additives, a solvent, and the like, and is manufactured by a film forming apparatus (not shown) using a well-known solution film forming method. The manufactured long base material 11 is wound in a roll, and is advanced to the next processing.

The resin layer 12 is formed of a resin on one surface 11a of the base material 11, and forms the laminated film 10 with the base material 11. The resin layer 12 functions as a moisture proof layer, and suppresses release of moisture passed by the base material 11 having a high moisture permeability to the external environment. The resin layer 12 improves the folding workability of the laminated film 10 without impairing the processability of the base material 11. The laminated film 10 is configured as described above, so that in a case where the base material 11 supplies water vapor existing in an air inside the packaging material and releases the absorbed moisture to the outside of the packaging material according to the humidity of the outside of the packaging material, the resin layer 12 disposed on the outermost layer of the packaging material suppresses the release. Therefore, the release of the moisture of the base material 11 is suppressed by the resin layer 12, and an excessive decrease in humidity in the inner space of the packaging material can be suppressed. In addition, even though the packaging material is processed to be folded, the folded portion is hardly damaged. Since these effects can be more appropriately exhibited, it is preferable to dispose the resin layer 12 outside in forming the packaging material with the laminated film 10. The other surface 11b of the base material 11 forms an inner surface of the packaging material. The other layer may be formed on the surface 11b, and in this case, the other layer forms the inner surface of the packaging material.

Here, the moisture permeation resistance will be described. A moisture permeation resistance R is calculated as a reciprocal of the moisture permeability, and indicates the difficulty of passing water vapor. Specifically, when the moisture permeability is denoted by A (g/m²·day), the moisture permeation resistance R is 1/A. Therefore, the moisture permeation resistance R per unit thickness of a material is obtained by dividing the moisture permeation resistance R by a thickness of the material. For example, when the thickness of the film is denoted by d (unit is μm), the moisture permeation resistance R per unit thickness of the film is calculated by a calculation formula of R/d (unit is (m²·day/g)/μm), that is, (1/A)/d.

The moisture permeation resistance R of the resin layer 12 can be calculated from the moisture permeability A of each of the laminated film 10 and the base material 11. The reason for this is that in the laminated film, the moisture permeability and the moisture permeation resistance are additive. Therefore, when the moisture permeation resistance of the resin layer 12 is denoted by R12, the thickness thereof is denoted by T12, the moisture permeation resistance of the base material 11 is denoted by R11, the thickness thereof is denoted by T11, and the moisture permeability of the laminated film 10 is denoted by A10, A10=1/(R12+R11) is satisfied. When the moisture permeation resistance of the laminated film 10 is denoted by R10, R10=R11+R12 is satisfied. Therefore, in a case where a moisture permeability A12 of the resin layer 12 is not measured, the moisture permeation resistance R12 of the resin layer 12 can be calculated based on the above calculation formula.

It is preferable that the moisture permeation resistance R12 of the resin layer 12 per 1 μm of the thickness of the resin layer 12 is in a range of 3.0×10⁻⁵ (m2·day/g)/μm or more and 7.5×10⁻⁴ (m²·day/g)/μm or less. More preferably, it is in a range of 3.1×10⁻⁵ (m²·day/g)/μm or more and 6.0×10⁻⁴ (m²·day/g)/μm or less, and still more preferably, it is in a range of 3.5×10⁻⁵ (m²·day/g)/μm or more and 2.0×10⁻⁴ (m²·day/g)/μm or less. Since the moisture permeation resistance R12 per 1 μm of the thickness of the resin layer 12 is in a range of 3.0×10⁻⁵ (m²·day/g)/μm or more, the moisture permeability A12 of the resin layer 12 is more suppressed to be smaller than the moisture permeability A11 of the base material 11, and the function of the resin layer 12 as a moisture proof layer is more moderately exhibited than in a case where the moisture permeation resistance R12 is less than 3.0×10⁻⁵ (m²·day/g)/μm. Further, the moisture permeability A10 of a whole of the laminated film 10 can be set to the specific range as described above. Since the moisture permeation resistance R12 per 1 μm of the thickness T12 of the resin layer 12 is 7.5×10⁻⁴ (m²·day/g)/μm or less, the resin layer 12 is less likely damaged in a folded state, than in a case where the moisture permeation resistance R12 is more than 7.5×10⁻⁴ (m²·day/g)/μm. This is because, in a case where the moisture permeation resistance R12 per 1 μm of the thickness of the resin layer 12 is high, the resin layer 12 is formed to be thin in order to achieve the moisture permeability required for the packaging material, but in a case where the resin layer 12 is too thin, the packaging material is likely to be damaged in a folded state.

It is preferable that the thickness T12 of the resin layer 12 is in a range of 2 μm to 80 μm. More preferably, it is in a range of 4 μm to 50 μm, and still more preferably, it is in a range of 10 μm to 40 μm. In a case where the thickness T12 is 2 μm or more, damage in achieving the moisture permeability required for the packaging material is less likely to occur than in a case where it is less than 2 μm. Further, in a case where the thickness T12 is 80 μm or less, there is less concern that it becomes thick as the packaging material, and the function as the moisture proof layer is not easily exhibited moderately than in a case where it is more than 80 μm.

The resin layer 12 as described above is formed of a resin on the surface 11a by using the base material 11 as a support. As a method of forming the resin layer 12, any method is applicable as long as the method can form the resin layer 12 on the surface 11a without impairing the function of the base material 11. Therefore, for example, it may be formed by applying a resin composition containing the resin forming the resin layer 12, or may be formed by sticking an independent film formed from this resin composition to the base material 11.

In the present embodiment, as an example, the resin layer 12 is formed by applying a resin composition prepared for coating (hereinafter, referred to as a coating resin composition) to the surface 11a. The resin layer 12 is satisfactorily formed without fear of peeling off from the base material 11 or the like. It is necessary that the resin layer 12 of the present invention has any one of a composition including an acrylic resin and a cellulose derivative, a silicone elastomer, or a urethane elastomer. By preparing a resin composition containing these, the resin layer 12 can be formed.

In a case where a film formed from the resin composition is formed as the resin layer 12 by being stuck to the base material 11, the resin layer 12 can be formed on the surface 11a by a laminating apparatus commonly used. For example, there is a method in which the surface 11a and the resin layer 12 are stuck together via a pressure sensitive adhesive or an adhesive.

A composition including an acrylic resin and a cellulose derivative (hereinafter, referred to as an acrylic resin blend), that is, an acrylic resin constituting a blend with a cellulose resin is not particularly limited as long as the acrylic resin can be blended with the cellulose derivative. The acrylic resin not only has the compatibility with the cellulose derivative which is the other component of the blend, but also can form a resin composition by adding other components such as a solvent and other additives that are added as necessary, and is preferably excellent in compatibility with these. In some cases, it is preferable to use an acrylic resin excellent in transparency.

Specific examples of the acrylic resin constituting the resin layer 12 include methyl acrylate, methyl methacrylate, and copolymers thereof with an acrylic acid and/or a methacrylic acid. In the present specification, the acrylic resin mainly means an acrylic acid, a methacrylic acid, and derivatives thereof, for example, a polymer such as acrylamide and acrylonitrile. Therefore, for example, acrylic resin includes methyl acrylate and methyl methacrylate.

Specifically, the acrylic resin is not particularly limited, but for example, an acrylic resin containing 50% to 99% by mass of a methyl acrylate unit and 1% to 50% by mass of another monomer unit which is copolymerizable therewith can be used. Specific examples of a monomer include acrylic acid ester such as methyl acrylate, ethyl acrylate, n-butyl acrylate, i-butyl acrylate, (2-ethyl) hexyl acrylate, lauryl acrylate, benzyl acrylate, glycidyl acrylate, glycidyl acrylate, and dicyclopentanyl acrylate. These monomers may be polymerized either alone or in combination of two or more kinds. Resins obtained by using, in addition to the monomer such as acrylic acid ester, monomers such as aromatic vinyl monomers such as styrene and α-methylstyrene; conjugated dienes such as butadiene and isoprene; macromonomers having a polymerizable unsaturated group such as an acryloyl group at one end of a polymer chain such as polystyrene, polymethyl acrylate, polyethyl acrylate, and polybenzyl acrylate; and phenolic hydroxyl group-containing monomers such as o-hydroxystyrene, m-hydroxystyrene, and p-hydroxystyrene alone or in combination of two or more kinds are used. As the acrylic resin contained in the resin layer 12, among these, an acrylic resin obtained by copolymerizing a methyl acrylate or methyl methacrylate unit in an amount of 50% by mass or more is preferable because of good compatibility with the cellulose acylate and excellent transparency, and those obtained by further copolymerizing ethyl, propyl, n-butyl, and i-butyl of an acrylic acid or a methacrylic acid are more preferable.

The acrylic resin preferably has a molecular weight in a range of 5,000 to 1,000,000, more preferably in a range of 10,000 to 800,000, and particularly preferably in a range of 20,000 to 500,000. In a case where the molecular weight is in a range of 5,000 to 1,000,000, the resin layer is hardly cracked, and the compatibility with the cellulose acylate is favorable. The molecular weight of the acrylic resin is a weight-average molecular weight (Mw) estimated by a gel permeation chromatography (GPC) method based on a calibration curve prepared using a polystyrene standard substance.

As the acrylic resin according to the present invention, a commercially available product can be used. Specifically, various homopolymers and copolymers manufactured using the above-described monomer as a raw material are commercially available, and preferred one can be appropriately selected from these. For example, Dianal (registered trademark) BR series (Dianal BR-87, BR-77, BR-113, and the like, manufactured by Mitsubishi Rayon Co., Ltd.), Delpet (registered trademark) 60N, 80N (manufactured by Asahi Kasei Corporation), Sumipex (registered trademark) MH5 (manufactured by Sumitomo Chemical Co., Ltd.), and KT75 (manufactured by Denka Company Limited.) are used. Two or more types of acrylic resins may be used in combination.

A cellulose derivative constituting a blend with the acrylic resin is not particularly limited as long as it is a cellulose resin that can be blended with the acrylic resin. In the present embodiment, the resin layer 12 is formed by applying a coating resin composition 47 (see FIG. 6) to the surface 11a. Therefore, the cellulose derivative not only has the compatibility with the acrylic resin which is the other component of the blend, but also can form a resin composition by adding other components such as a solvent and other additives that are added as necessary, and is preferably excellent in compatibility with these. In some cases, it is preferable to use a cellulose derivative excellent in transparency.

Specifically, the cellulose derivative constituting the resin layer 12 is not particularly limited, but includes, for example, cellulose esters, such as nitrocellulose; cellulose acylate such as acetylcellulose, diacetylcellulose, and triacetylcellulose; cellulose acetate propionate; and cellulose acetate butyrate. The same cellulose acylate as used for the base material 11 can be used. Among these cellulose derivatives, a mixed fatty acid ester including two or more types of acyl groups can be preferably used for reason of the compatibility with the acrylic resin. In this case, the acyl group is preferably an acetyl group and an acyl group having 3 to 4 carbon atoms. In a case where a mixed fatty acid ester is used, a degree of substitution of the acetyl group is preferably less than 2.5, and more preferably less than 1.9. On the other hand, a degree of substitution of the acyl group having 3 to 4 carbon atoms is preferably 0.1 to 1.5, more preferably 0.2 to 1.2, and particularly preferably 0.5 to 1.1. Specifically, it is preferable to use cellulose acetate butyrate and cellulose acetate propionate.

As the cellulose derivative according to the present invention, a commercially available product can be used. Specific examples include CAP-482-20 (manufactured by Eastman Chemical Company), which is cellulose acetate propionate, and CAB-381-20 (manufactured by Eastman Chemical Company), which is cellulose acetate butyrate. Two or more types of cellulose derivatives may be used in combination.

The acrylic resin blend constituting the resin layer 12 is not particularly limited as long as the resin layer 12 can be formed on the surface 11a. In the present embodiment, the resin layer 12 is formed on the surface 11a by applying the coating resin composition 47 (see FIG. 6). Accordingly, the acrylic resin blend constituting the coating resin composition 47 (see FIG. 6) can be used without limitation as long as it can form the coating resin composition 47 with TAC. In a content ratio of the acrylic resin and the cellulose derivative in the acrylic resin blend, by weight, when the acrylic resin blend is 100, the acrylic resin is in a range of 90 or more and 20 or less, preferably 80 or more and 30 or less, and still more preferably 80 or less and 40 or less. In a case where the acrylic resin is 90 or more, there is less concern that the resin layer is likely to be cracked than in a case where the acrylic resin is more than 90. Further, in a case where the acrylic resin is 20 or less, there is less concern that the function of the moisture proof layer cannot be obtained than in a case where the acrylic resin is more than 20.

The acrylic resin blend can be appropriately adjusted, for example, by adding an additive or adjusting a viscosity by a solvent or the like, according to a method of applying the coating resin composition 47 (see FIG. 6). Preferred examples of the additive include a plasticizer, a matting agent, a deterioration inhibitor, and an ultraviolet absorber. The plasticizer can be appropriately selected in view of the function of the moisture proof layer and the easiness to be cracked of the resin layer. The coating resin composition 47 (see FIG. 6) which will be described later is prepared from the acrylic resin blend and these additives. In a preparation method, examples of a solvent include a hydrocarbon solvent such as benzene or toluene; a halogenated hydrocarbon solvent such as methylene chloride or chlorobenzene; an alcohol solvent such as methanol, ethanol, or isopropanol; a ketone solvent such as acetone, methyl ethyl ketone, or methyl isobutyl ketone; an ester solvent such as methyl acetate, ethyl acetate, or propyl acetate; an ether solvent such as tetrahydrofuran or methyl cellosolve; and the like, and these may be used alone or in combination of two or more.

The coating resin composition 47 (see FIG. 6) containing the acrylic resin blend is applied to the surface 11a and then cured to form the resin layer 12. A curing method is appropriately selected depending on the types of the acrylic resin and the cellulose derivative contained in the acrylic resin blend, but curing is performed by heating. For example, after application, the composition is cured by appropriately selecting heating means such as heating with a heater, blowing hot air, or placing in an oven, and performing heating under predetermined conditions. A time for curing and other conditions can be appropriately adopted according to the types of the acrylic resin and the cellulose derivative contained in the acrylic resin blend.

The silicone elastomer constituting the resin layer 12 is not particularly limited as long as the resin layer 12 can be formed on the surface 11a. In the present embodiment, the resin layer 12 is formed on the surface 11a by applying the coating resin composition 47 (see FIG. 6). Accordingly, the silicone elastomer constituting the resin layer 12 can be used without limitation as long as it can be used as the coating resin composition 47. Above all, a liquid silicone elastomer is selected because it is easy to prepare a coating liquid and the surface of the resin layer 12 can be smoothed by self-leveling. As the silicone elastomer, both an addition type and a condensation type can be used. However, the addition type silicone elastomer is preferable because it does not generate by-products and has a small reduction by curing.

The coating resin composition 47 (see FIG. 6) containing the silicone elastomer can be appropriately adjusted, for example, by adding an additive or adjusting a viscosity by a solvent or a diluent, according to an application method. The silicone elastomer used in the present invention may be one that is cured at a room temperature or one that is cured by heating.

The coating resin composition 47 (see FIG. 6) containing the silicone elastomer is applied to the surface 11a and then cured to form the resin layer 12. A curing method is appropriately selected depending on the type of the contained silicone elastomer. For example, in a case where the silicone elastomer is cured at a room temperature, it is cured by being allowed to stand at a room temperature after application. In a case where the silicone elastomer is cured by heating, after application, it is cured by appropriately selecting heating means such as heating with a heater, blowing hot air, or placing in an oven, and performing heating under predetermined conditions. A time for curing and other conditions can be appropriately adopted according to the resin composition, the contained silicone elastomer, and the like.

As the silicone elastomer according to the present invention, a commercially available product can be used. Specifically, examples of the addition type silicone elastomer include “TSE3033” and “TSE3320” (manufactured by Momentive Performance Materials Japan, Inc.) which are sold as a two-component heat-curable adhesive liquid silicone rubber, and “KE1212”, “KE1800”, and “KE109” (manufactured by Shin-Etsu Chemical Co., Ltd.). Two or more types of silicone elastomers may be used in combination.

The urethane elastomer constituting the resin layer 12 is not particularly limited as long as the resin layer 12 can be formed on the surface 11a. In the present embodiment, the resin layer 12 is formed on the surface 11a by applying the coating resin composition 47 (see FIG. 6). Alternatively, the resin layer 12 is formed on the surface 11a by laminating a film formed from a resin composition containing the urethane elastomer on the base material 11. Accordingly, the urethane elastomer constituting the resin layer 12 can be used without limitation as long as it can be used as the coating resin composition 47 or a film. Above all, a liquid, a powdery, or a pellet-like urethane elastomer is selected because it is easy to prepare a coating liquid.

The coating resin composition 47 (see FIG. 6) containing the urethane elastomer can be appropriately adjusted, for example, by adding an additive or adjusting a viscosity by a solvent or a diluent, according to an application method. The urethane elastomer used in the present invention may be one that is cured by ultraviolet rays or one that is cured by heating or the like.

The coating resin composition 47 (see FIG. 6) containing the urethane elastomer is applied to the surface 11a and then cured to form the resin layer 12. A curing method is appropriately selected depending on the type of the contained urethane elastomer. For example, in a case where the urethane elastomer is cured by ultraviolet rays, it is cured by being irradiated with ultraviolet rays after application. In a case where the silicone elastomer is cured by heating, after application, it is cured by appropriately selecting heating means such as heating with a heater, blowing hot air, or placing in an oven, and performing heating under predetermined conditions. A time for curing and other conditions can be appropriately adopted according to the resin composition, the contained urethane elastomer, and the like.

As the urethane elastomer according to the present invention, a commercially available product can be used. Specifically, an ester (adipate) type, an ester (lactone) type, an ether type, a polycarbonate type, an aliphatic non-yellowing type, and the like can be used as a two-component curable polyurethane or thermoplastic polyurethane elastomer. Commercially available products include Pandex (registered trademark) GW series “GW-3670/HX-770” (manufactured by DIC Corporation) of a two-component curable continuous coating urethane film system; Elastollan (registered trademark) C80A, C85A, C90A, C95A, C64D, 1180A, 1185A, 1190A, 1195A, 1164D, ET385, ET880, ET885, ET890, ET858D, ET860D, ET864D, NY585, NY90A, NY1197A (manufactured by BASF Japan) as a thermoplastic polyurethane elastomer; Pandex (registered trademark) T-5105, T-5201, T-5265, T8175, T8180, T8185, T8190, T8195, DP9370A, 5377A, 588, KU2-8659, DP5094A (DIC Covestro Polymer Ltd.); Resamine (registered trademark) P-1000, P-7000, P-2000 series (manufactured by Dainichiseika Color & Chemicals Mfg. Co., Ltd.); and the like. Two or more types of urethane elastomers may be used in combination.

The shape of the packaging material is not limited as long as the packaging material is formed of the laminated film 10. However, in order to sufficiently exhibit the function of adjusting the amount of water vapor in the space inside the packaging material, it is preferable to adopt a shape configured so that the resin layer 12 of the laminated film 10 is disposed outside the packaging material. Thereby, the effect of suppressing the release of the supplied moisture, after the base material 11 absorbs water vapor existing in the space inside the packaging material, to the outside of the packaging material according to the environment outside the packaging material is more effectively exhibited by the resin layer 12.

The shape of the packaging material is not particularly limited as long as the packaging material is formed of the laminated film 10 and can package the object to be packaged. For example, it is possible to simply wrap the object to be packaged with the laminated film 10 as a film-like packaging material. In addition, the packaging material can be formed into a bag shape, a box shape, a cylindrical shape, and other shapes by processing the laminated film 10. A processing method can be adopted without particular limitation as long as the laminated film 10 can be processed into the shape of the packaging material.

For example, as shown in FIG. 2, a bag-shaped packaging material 14 in which the laminated film 10 has a bag shape can be used. The packaging material 14 is formed into a bag-shaped packaging material by preparing two sheets of the laminated film 10 cut into a rectangular shape having a long side of 300 mm and a short side of 220 mm, disposing the resin layer 12 outside and overlapping these, and performing adhesion on three sides of two long sides and one short side by heat sealing to form a heat sealing part 16. The packaging material 14 has an opening 18 on a short side that is not heat-sealed, and has a width W14 of 220 mm and a height H14 of 300 mm, where a portion where a short side is heat-sealed is a width and a portion where a long side is heat-sealed is a height.

The object to be packaged is packaged by being put from the opening 18. In a case where the amount of water vapor in the space inside the packaging material 14 is adjusted to be kept moderate, the opening 18 is preferably sealed. Sealing means is not particularly limited as long as it is means capable of sealing the opening 18, and may be used by tape fixing, heat sealing, or the like. In the packaging material 14, since the base material 11 is disposed inside and the resin layer 12 is disposed outside, the base materials 11 are heat-sealed to each other. As described above, the base material 11 is configured to contain cellulose acylate, and thus the heat sealability is favorable.

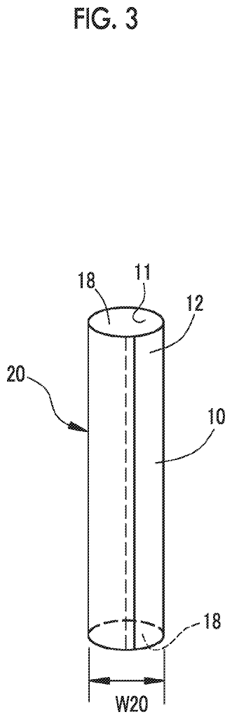

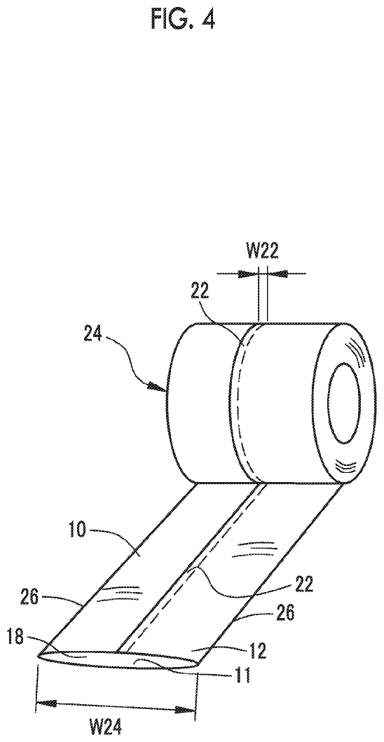

For example, as shown in FIG. 3, a cylindrical-shaped packaging material 20 in which the laminated film 10 has a cylindrical shape can be used. The packaging material 20 is formed from a packaging material roll 24 shown in FIG. 4 and formed of the long laminated film 10 having a width of 310 mm Both ends of the laminated film 10 in a width direction are adhered to each other with an adhesive in a state where 10 mm at the both ends are overlapped as a margin 22, and then are wound in a roll shape to form the packaging material roll 24. A width W22 of the overlapped portion of the margin 22 is 10 mm Therefore, a width W24 of the packaging material roll 24 in a width direction is 150 mm. The packaging material 20 is obtained by cutting a predetermined length from the packaging material roll 24. A width W20 of the packaging material 20 is approximately 96 mm in a case where the packaging material 20 has a substantially columnar shape.

The two openings 18 of the packaging material 20 may or may not be closed. In a case where the amount of water vapor in the space inside the packaging material 20 is adjusted to be kept moderate, both the opening 18 are preferably sealed. Sealing means may be the same as that of the packaging material 14. Further, a lid and/or a bottom formed by another member may be provided. In a case where the both ends of the laminated film 10 in a width direction are overlapped to be adhered to each other, the base material 11 is on the inside and the resin layer 12 is on the outside. Therefore, also in the packaging material 20, the inside is the base material 11 and the outside is the resin layer 12.

An end of the packaging material roll 24 in a width direction is a folded portion 26. The folded portion 26 is formed by folding the laminated film 10 with the resin layer 12 disposed outside, but the folded portion of the packaging material of the embodiment of the present invention is hardly damaged. Therefore, it is preferable because the packaging material has the folded portion, so that the packaging materials having various shapes according to the object to be packaged can be formed.

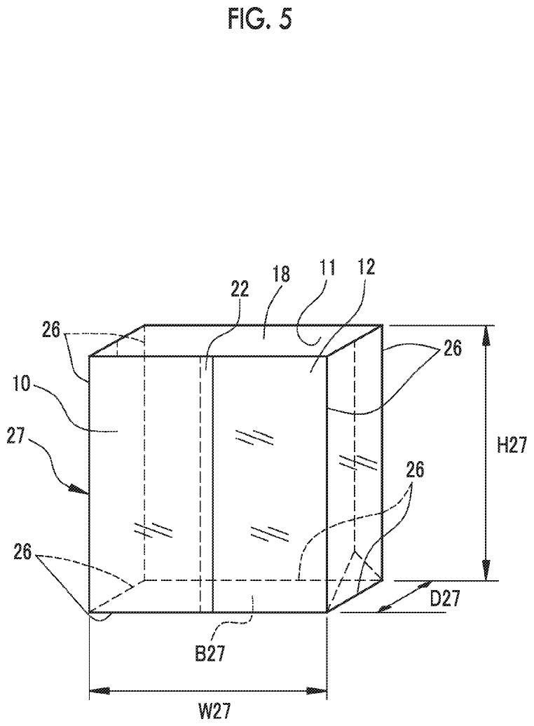

For example, as shown in FIG. 5, a box-shaped packaging material 27 in which the laminated film 10 has a box shape can be used. The packaging material 27 is formed into a rectangular parallelepiped shape having a rectangular bottom B27 formed by folding the laminated film 10 in one opening portion of a cylindrical packaging material and adhering it with an adhesive, and processing it into a so-called bottom gusset shape. The illustration of the gusset is omitted. The other opening is opened to form the opening 18. The packaging material 27 has the margin 22 and the opening 18. In the rectangular bottom B27, a width W27 of the packaging material 27 which is a long side is 150 mm, a gusset width D27 which is a short side is 90 mm, and a height H27 when the opening 18 is an upper surface is 280 mm Therefore, the cylindrical packaging material before being processed into a box shape has a width of 480 mm.

In the cylindrical packaging material, the base material 11 is on the inside and the resin layer 12 is on the outside in a case where the both ends of the laminated film 10 in the width direction are overlapped to be adhered to each other, and thus the packaging material 27 also has the base material 11 inside the packaging material and the resin layer 12 outside the packaging material. The packaging material 27 has the folded portion 26. This folded portion 26 is preferable because it is hardly damaged as described above and can form the packaging materials having various shapes according to the object to be packaged.

In the present embodiment, as described above, a method of applying a coating resin composition is adopted as a method of forming the resin layer 12 on the surface 11a, and the resin layer 12 can be manufactured by a laminated film manufacturing apparatus. The laminated film manufacturing apparatus 30 shown in FIG. 6 is an example of an apparatus for continuously manufacturing the laminated film 10. The laminated film manufacturing apparatus 30 comprises a feeder 31, a resin layer forming unit 32, a drying device 33, and a winder 34 in order from an upstream side in a handling direction of the long base material 11. Further, the laminated film manufacturing apparatus 30 comprises a roller 44. Although a plurality of the rollers 44 are provided, FIG. 6 shows only one. The roller 44 handles the base material 11 by supporting the base material 11 from below on a peripheral surface and rotating about a rotation axis. In this example, the base material 11 is made by a film forming apparatus (not shown) using a well-known solution film forming method. As described above, the base material 11 contains cellulose acylate as an essential component, and in the present embodiment, the above-described TAC is used.

The feeder 31 continuously feeds the long base material 11. The base material 11 is set on the feeder 31 in a state of being wound in a roll shape around a winding core 38, and the base material 11 is continuously fed by allowing the winding core 38 to rotate.

The resin layer forming unit 32 is used for continuously forming the resin layer 12 on the surface 11a. The resin layer forming unit 32 comprises an application device 41 and an infrared heater 42.

The application device 41 is used for applying the coating resin composition 47 for forming the resin layer 12 on the surface 11a. In addition, the coating resin composition 47 is described as a “composition” in FIG. 6. The application device 41 causes the supplied coating resin composition 47 to continuously flow out from an outlet 41a facing the surface 11a. The application device 41 causes the coating resin composition 47 to continuously flow out to the base material 11 being handled, so that the coating resin composition 47 is continuously applied to the surface 11a.

The infrared heater 42 is used for curing the coating resin composition 47 by heating the base material 11. The infrared heater 42 is provided such that an emission surface for emitting infrared rays faces the base material 11 to be handled. The infrared heater 42 may be disposed so as to face the surface 11a on which a coating film 48 formed from the coating resin composition 47 is formed, and may be disposed so as to face the surface 11b which is a film surface on an opposite side to the surface 11a as in the present embodiment shown in FIG. 6.

Instead of or in addition to the infrared heater 42, a blowing-type blower that blows a heated gas to the base material 11 or a chamber-type blower that surrounds a handling path of the base material 11 with a chamber and supplies a heated gas to the chamber may be used. In a case where a resin composition that is cured by ultraviolet rays is used, an ultraviolet irradiation device is provided so as to face the surface 11a.

The resin layer 12 is formed on the base material 11 that has passed through the infrared heater 42, and the base material 11 is dried by being guided to the drying device 33. In the present embodiment, as the drying device, a chamber-type drying device that surrounds the handling path with a chamber and supplies a heated gas to the chamber is used, but is not particularly limited. By this drying, the contained solvent evaporates, and the laminated film 10 is obtained in a long length. The laminated film 10 is guided to the winder 34 and wound around a set winding core 49 in a roll shape.

The packaging material of the embodiment of the present invention is configured as described above. Therefore, even though a package in which an object to be packaged is put in the packaging material and then packaged in a sealed state is stored for a long time while being refrigerated, the packaging material of the embodiment of the present invention does not cause dew condensation inside the packaging material and suppresses drying of an object to be packaged, so that deformation after water absorption is small. Moreover, damage due to folding of the packaging material is less likely to occur. Therefore, according to the packaging material of the embodiment of the present invention, for example, in a case where the object to be packaged is a fruit or vegetable, long-time storage is possible while maintaining the freshness of the fruits and vegetables. The present invention is suitable for packaging the object to be packaged for which it is preferable to keep water vapor inside the packaging material moderate and to suppress the drying of the object to be packaged. Therefore, examples of the preferred object to be packaged include, in addition to the fruits and vegetables, plants including flowers and the like, culture media for culturing cells, foods, and the like.

As shown in FIG. 7, a package 28 which is an example of the method of using the packaging material of the embodiment of the present invention performs packaging in a sealed state by putting broccoli which is a fruit or vegetable as an object to be packaged 25 into the packaging material 14, folding an upper portion of the packaging material 14 in FIG. 7, and fastening the opening 18 by a tape 29 in a closed state. Since the folded portion 26 is hardly damaged, the packaging material 14 can perform packaging in a sealed state by easy means for folding and fastening by the tape 29. Further, means such as heat sealing may be used to close the opening 18.

For example, fruits and vegetables maintain physiological actions such as moisture release and respiratory action. Therefore, in a case where the packaging materials 14, 20, and 27 are used, the effect of suppressing dew condensation due to moisture contained in the laminated film 10 and adjusting the humidity inside the packaging material is reliably obtained by the action of the base material 11 and the resin layer 12. Examples of such fruits and vegetables include flower vegetables such as broccoli and rape, leafy vegetables such as spinach and komatsuna, fruit vegetables such as bell peppers, eggplants, tomatoes, cucumbers, strawberries, and edamames, fruits such as bananas, grapes, apples, pears, and mandarins, root vegetables such as yam and burdock, mushrooms such as shiitake mushrooms and shimeji mushrooms, and cut flowers such as chrysanthemums and lilies. Among these, flower vegetables, leafy vegetables, fruit vegetables, mushrooms, and cut flowers are particularly preferably packaged using the packaging material for reasons such as a large amount of moisture release and noticeable dew condensation during long-time storage and distribution in refrigeration.

In the packaging materials 11, 20, and 27, dew condensation and discoloration are suppressed during room temperature storage, and dew condensation or discoloration is prevented during refrigeration, and thus long-time storage is possible. Since dew condensation is suppressed, mold is also suppressed. Room temperature storage refers to storage in a range of 10° C. to 30° C., and refrigerated storage refers to storage in a range of 0° C. to 10° C. Since the packaging materials 14, 20, and 27 can sufficiently prevent dew condensation during refrigeration, more preferable effects can be obtained in refrigerated storage.

In order to maintain the freshness of fruits and vegetables, refrigerated storage is preferably performed, and the temperature during storage is preferably in a range of 0° C. to 10° C. In general, air is cooled by a heat exchanger in refrigerated storage. However, in this case, the moisture in the air is removed in the heat exchanger, and the humidity in a refrigerator is likely to decrease. On the other hand, the amount of saturated water vapor in the air at the refrigerated storage temperature is smaller than that at a room temperature. Therefore, dew condensation occurs in a case where humidification or packaging of fruits and vegetables is performed during refrigerated storage. In a case where a packaging material in the related art or a packaging material for modified atmosphere (MA) packaging using fine pores is used in refrigerated storage, the packaging material has low moisture permeability, and thus dew condensation easily occurs inside the packaging material due to the moisture released from fruits and vegetables. The occurrence of dew condensation leads to, for example, the generation and growth of mold, the suppression of respiration of fruits and vegetables due to dew condensation on the surface of the fruits and vegetables, the deterioration in the MA packaging effect due to blocking of fine pores, and the like. The packaging materials 14, 20, and 27 absorb and release moisture according to the humidity change inside the packaging material by the equilibrium moisture content of the base material 11, so that dew condensation is prevented inside the packaging material. In addition, the resin layer 12 prevents excessive release of moisture, and maintains the humidity so as to suppress drying of fruits and vegetables.

The packaging materials 14, 20, and 27 can be used for both sealing packaging and unsealing packaging. However, in a case where the packaging material is provided for sealing packaging, an improvement in the effect of suppressing dew condensation, and the effect of suppressing discoloration of fruits and vegetables and the mold suppression effect in a case where the object to be packaged is the fruits or vegetable are more remarkably confirmed. The suppression of mold refers to the suppression of the generation and growth of mold. In addition, sealing packaging is more preferable than unsealing packaging from a viewpoint of suppressing contamination of fruits and vegetables by germs and dirt, and drying of fruits and vegetables. The sealing packaging is, for example, so-called sealing packaging in which fruits and vegetables are put into the packaging material 14, and the opening 18 is closed by an adhesive tape, that is, sealed. However, the aspect of the sealing packaging is not limited thereto. Unsealing packaging includes so-called handkerchief packaging in which an object is placed on a packaging material having a rectangular sheet shape, and four corner ends are twisted together at the top. The unsealing packaging also includes packaging using a packaging material having a plurality of fine pores penetrating in a thickness direction. In a case where the laminated film 10 is formed into various packaging materials, it is not limited to the formation by heat sealing, and may be formed using an adhesive or a pressure sensitive adhesive.

### Second Embodiment

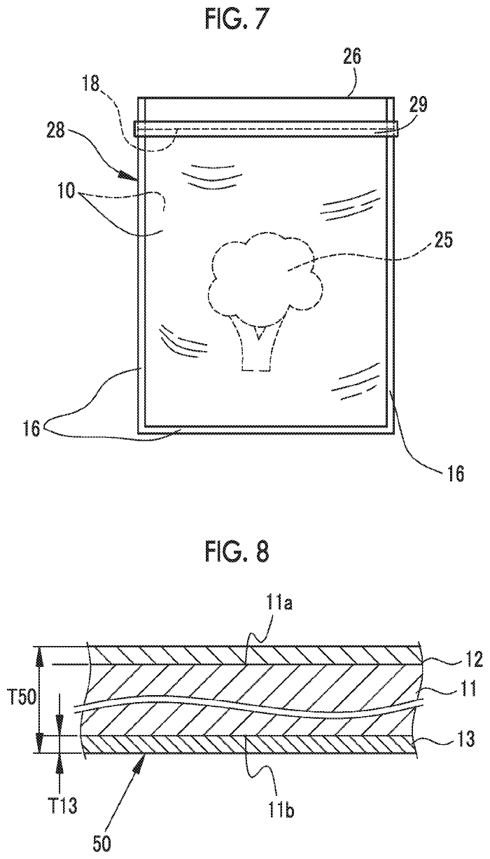

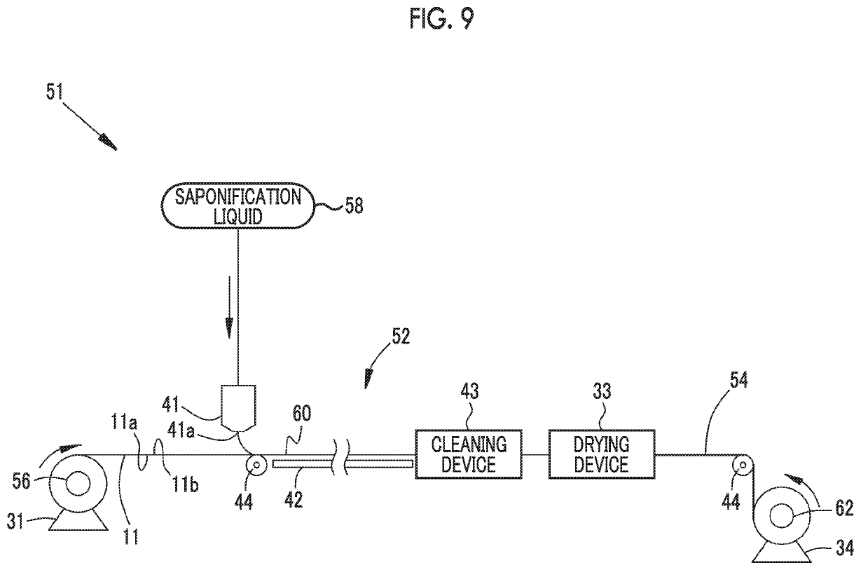

In the present embodiment, as shown in FIG. 8, a laminated film 50 has the base material 11 and the resin layer 12, and has a saponified layer 13 on the surface 11b. The saponified layer 13 is a layer formed by performing a saponification treatment on the surface 11b side, and is a layer containing saponified cellulose acylate. The laminated film 50 of the present embodiment is the same as that of the first embodiment except that the laminated film 50 has the saponified layer 13. Therefore, description of the same members as in the first embodiment will be omitted. In FIG. 8, members and the like denoted by the same reference numerals as those in FIGS. 1 to 7 are the same as those described in the first embodiment, and thus a description thereof will be omitted.

The saponified layer 13 is formed of saponified cellulose acylate. In the present embodiment, saponified TAC is formed by a saponification treatment that is an alkali hydrolysis reaction of a cellulose ester. By the saponification treatment, an acyl group contained in the cellulose acylate becomes a hydroxy group by a substitution reaction, and the acyl group decreases. The saponified layer 13 of cellulose acylate having a hydroxy group has hydrophilicity. Therefore, by providing the saponified layer 13 on the surface 11b and disposing the saponified layer 13 inside the packaging material, the inside of the packaging material has hydrophilicity. Thereby, for example, even though water vapor that cannot be completely absorbed by the base material 11 is generated in the inner space of the packaging material, the surface of the saponified layer 13 has hydrophilicity, so that moisture due to water vapor is used to form a water film, and thus dew condensation hardly occurs inside the packaging material. As described above, the saponified layer 13 is preferable because dew condensation is more highly prevented.

A thickness T13 of the saponified layer is preferably in a range of 1 μm to 6 μm, and more preferably in a range of 2 μm to 5 μm. In the present embodiment, it is 2 μm. In a case where the thickness T13 is 1 μm or more, an initial anti-fogging property, that is, the function of preventing instantaneous dew condensation is more excellent than in a case where the thickness T13 is less than 1 μm, and for example, in a case where the package is placed in a refrigerator, dew condensation hardly occurs inside the packaging material, which is preferable. On the other hand, in a case where it is 6 μm or less, a long-term anti-fogging property, that is, the function of preventing dew condensation for a long time is more excellent than in a case where it is more than 6 μm, and the effect that dew condensation hardly occurs inside the packaging material lasts for a long time, which is preferable. In the present embodiment, the thickness T13 is obtained by the following method. A sample sampled from the base material 11 is immersed in dichloromethane for 24 hours. The sample remaining not dissolved by this immersion was dried, and the thickness of the dried sample was measured three times. An average of the three measured values is defined as the thickness T13.

In the present embodiment, the saponified layer 13 can be formed by a laminated film forming apparatus. A laminated film forming apparatus 51 shown in FIG. 9 is an example of an apparatus for continuously manufacturing a laminated film material 54 that is a part of the laminated film 50 and includes the base material 11 and the saponified layer 13. The laminated film 50 comprises the base material 11, the resin layer 12, and the saponified layer 13, and the laminated film forming apparatus 51 shown in FIG. 9 forms the saponified layer 13 on the base material 11. Therefore, the laminated film material 54 including the base material 11 and the saponified layer 13 is manufactured by the laminated film forming apparatus 51, and thereafter, the laminated film 50 is manufactured by forming the resin layer 12 on the laminated film material 54. Specifically, the laminated film material 54 is manufactured by the laminated film forming apparatus 51, wound up by a winding core 62, and then sent to the laminated film manufacturing apparatus 30 (see FIG. 6). Therefore, in the laminated film manufacturing apparatus 30 (see FIG. 6), the laminated film material 54 is provided instead of the base material 11, a resin layer 12 is formed on the surface 11a of the laminated film material 54, and the laminated film 50 is manufactured. The order in which the resin layer 12 and the saponified layer 13 are formed on the base material 11 is not limited to this. For example, the saponified layer 13 may be formed after the resin layer 12 is formed on the base material 11, or the resin layer 12 and the saponified layer 13 may be formed on the base material 11 at the same time.

The laminated film forming apparatus 51 comprises the feeder 31, a saponification unit 52, the drying device 33, and the winder 34 in order from an upstream side in a handling direction of the long base material 11. Further, the laminated film manufacturing apparatus 30 comprises a roller 44. Although a plurality of the rollers 44 are provided, FIG. 9 shows only two of them. The roller 44 handles the base material 11 or the laminated film material 54 by supporting the base material 11 or the laminated film material 54 from below on a peripheral surface and rotating about a rotation axis. The base material 11 forms the laminated film 50, and in this example, is made by a film forming apparatus (not shown) using a well-known solution film forming method. As described above, the base material 11 contains cellulose acylate as an essential component, and in the present embodiment, the above-described TAC is used.

The feeder 31 continuously feeds the long base material 11. The base material 11 is set on the feeder 31 in a state of being wound in a roll shape around a winding core 56, and the base material 11 is continuously sent out by allowing the winding core 56 to rotate.

The saponification unit 52 is used for continuously saponifying the base material 11 to form the laminated film material 54. The saponification unit 52 comprises the application device 41, the infrared heater 42, and a cleaning device 43.

The application device 41 is used for applying a saponification liquid 58 to the surface 11b. The application device 41 causes the supplied saponification liquid 58 to continuously flow out from the outlet 41a facing the surface 11b. The application device 41 causes the saponification liquid 58 to continuously flow out to the base material 11 being handled, so that the saponification liquid 58 is continuously applied to the surface 11b. Examples of the method of the saponification treatment include, as in the present embodiment, a method of applying the saponification liquid 58 by immersion in addition to a method of applying the saponification liquid 58 by coating.

The saponification liquid 58 is used for saponifying the surface 11b side of the base material 11 to form the saponified layer 13 (see FIG. 8), and contains an alkali and water. An alkali is potassium hydroxide (KOH) in the present embodiment, but is not limited thereto, and sodium hydroxide (NaOH) may be used instead of KOH. In this example, the saponification liquid 58 contains an alcohol having 2 to 3 carbon atoms in addition to an alkali and water, and the application device 41 applies the saponification liquid 58 to apply an alcohol to the surface 11b. An alcohol is used for promoting the permeation of the alkali into the base material 11. As the alcohol having 2 to 3 carbon atoms, isopropyl alcohol is particularly preferable, and also in the present embodiment, isopropyl alcohol is used.

In this example, the alcohol is applied by applying a saponification liquid, but is not limited to this aspect. For example, a method of sequentially applying an alcohol and an alkaline aqueous solution may be used. In this case, it is more preferable to apply the saponification liquid after applying the alcohol.

The alcohol is applied to the surface 11b in an amount of at least 17 g per 1 m² of an area of the surface 11b, that is, in an application amount of 17 g/m² or more. The application amount of the alcohol is preferably in a range of 17 g/m² to 39.6 g/m², more preferably in a range of 22 g/m² to 39.6 g/m², and still more preferably in a range of 33.4 g/m² to 39.6 g/m².

The alkali is applied to the surface 11b in an amount of at least 0.3 g per 1 m² of an area of the surface 11b, that is, in an application amount of 0.3 g/m² or more. Thereby, the alkali is surely quickly permeated into the base material 11. The application amount of the alkali is preferably in a range of 0.3 g/m² to 1.3 g/m², more preferably in a range of 0.6 g/m² to 1.3 g/m², and still more preferably in a range of 0.7 g/m² to 1.3 g/m².

The infrared heater 42 is used for heating the base material 11 and maintaining it in a predetermined temperature range for a predetermined time. The infrared heater 42 is provided such that an emission surface for emitting infrared rays faces the base material 11 to be handled. The infrared heater 42 may be disposed so as to face the surface 11b on which a coating film 60 formed from the saponification liquid 58 is formed, but it is preferable that the infrared heater 42 is disposed so as to face the surface 11a which is a film surface on an opposite side to the surface 11b as in the present embodiment shown in FIG. 9, since the alkali is more reliably and more efficiently permeated through the surface 11b side.

Instead of or in addition to the infrared heater 42, a blowing-type blower that blows a heated gas to the base material 11 or a chamber-type blower that surrounds a handling path of the base material 11 with a chamber and supplies a heated gas to the chamber may be used.

In a case where the thickness T13 of the saponified layer 13 (see FIG. 8) is too small, the initial anti-fogging property is difficult to develop, and in a case where it is too large, the long-term anti-fogging property is difficult to develop. Therefore, in order to achieve both the initial anti-fogging property and the long-term anti-fogging property, the surface 11b is maintained at a temperature of 40° C. to 80° C. for 20 seconds to 120 seconds by heating with the infrared heater 42. By maintaining the temperature at 40° C. or higher, saponification proceeds more quickly than in a case where the temperature is lower than 40° C., and the saponified layer 13 having a larger thickness T13 is formed, so that the initial anti-fogging property reliably develops. By maintaining the temperature at 80° C. or lower, the evaporation of alcohol is more reliably suppressed and the saponified layer 13 is more reliably formed than in a case where the temperature is higher than 80° C., and furthermore, the saponified layer 13 having a small thickness T13 is formed, so that the long-term anti-fogging property reliably develops. The maintaining temperature is more preferably in a range of 40° C. to 70° C., and still more preferably in a range of 50° C. to 70° C.

A time for which the temperature is maintained in the above-described temperature range is set to 20 seconds to 120 seconds. By setting the time to 20 seconds or longer, saponification proceeds more quickly than in a case where the time is shorter than 20 seconds, and the saponified layer 13 having a larger thickness T13 (see FIG. 8) is formed, so that the initial anti-fogging property reliably develops. By setting the time in 120 seconds, the saponified layer 13 is formed to have a smaller thickness T13 (see FIG. 8) than in a case where the time is longer than 120 seconds, so that the long-term anti-fogging property reliably develops. The time for which the temperature is maintained in the above-described temperature range is more preferably 30 seconds to 100 seconds, and still more preferably 30 seconds to 50 seconds.

The cleaning device 43 is used for stopping saponification by cleaning the base material 11. The cleaning device 43 comprises a spray-type cleaning machine that sprays water on the surface 11b side on which the coating film 60 is formed. The alkali is quickly removed from the base material 11 by spraying water.

The saponified layer 13 is formed on the base material 11 that has passed through the cleaning device 43, and the base material 11 is guided to the drying device 33 and dried. In the present embodiment, as the drying device, a chamber-type drying device that surrounds the handling path with a chamber and supplies a heated gas to the chamber is used, but is not particularly limited. By this drying, the contained water evaporates, and the laminated film material 54 is obtained in a long length. The laminated film material 54 is guided to the winder 34 and wound around a set winding core 62 in a roll shape.

As described above, the laminated film material 54 wound around the winding core 62 is sent to the next processing, and the laminated film 50 is manufactured. That is, in the laminated film manufacturing apparatus 30 (see FIG. 6), by setting the winding core 62 instead of the winding core 38, the laminated film material 54 can be supplied, and the resin layer 12 can be formed on the surface 11a.

Hereinafter, examples of the present invention and comparative examples related to the present invention will be described.

### EXAMPLE

### Manufacture Example

A base material 11 having a width of 1.5 m was manufactured by a solution film forming apparatus (not shown), and wound to a length of 2,000 m by a winder, and used in the examples. The composition of a dope as the material of the base material 11 is as follows. The following solid content is a solid component constituting the base material 11.

| | |
|---|---|
| First component of solid content | 100 parts by mass |
| Second component of solid content | the column “Amount” |
| | in Table 1 or Table 2 |
| Third component of solid content | 1.3 parts by mass |
| Dichloromethane (first component of solvent) | 635 parts by mass |
| Methanol (second component of solvent) | 125 parts by mass |

The first component of the solid content represents cellulose acylate, and is described as “CA” in the column “Substance” of “First component” in Table 1 or Table 2. In the cellulose acylate, all acyl groups are acetyl groups, and the viscosity average degree of polymerization is 320. The acyl group substitution degree of the cellulose acylate is from 2.00 to 2.97. The acyl group substitution degree is shown in the column of “Acyl group substitution degree” in Table 1 or Table 2.

The second component of the solid content represents A or B shown in the column “Substance” of “Second component” in Table 1 or Table 2. A is an oligomer having an ester of an adipic acid and an ethylene glycol as a repeating unit (the molecular weight obtained by terminal functional group quantitation is 1,000), and B is a benzoic acid ester of sucrose (MONOPET (registered trademark) SB manufactured by DKS Co., Ltd.). A and B are plasticizers for cellulose acylate. The third component of the solid content represents fine particles of silica, and is R972 manufactured by Nippon Aerosil Co., Ltd. The thickness T11 of the formed base material 11 is shown in the column “Thickness of base material” in Table 1 or Table 2. Further, the moisture permeability of the base material 11 at 40° C. and RH of 90% is shown in the column “Moisture permeability of base material” in Table 1 or Table 2.

The dope was prepared by the following method. First, a first component of a solid content, a second component of a solid content, and a solvent which was a mixture of dichloromethane (first component of solvent) and methanol (second component of solvent) were put into a sealed container, and stirred in the sealed container in which the temperature was maintained at 40° C. to dissolve the first component and the second component of the solid content in the solvent. A third component of a solid content was dispersed in a mixture of dichloromethane and methanol, and the obtained dispersion was put into and dispersed in the sealed container containing the solution in which the first component and the second component of the solid component were dissolved. The dope obtained in this manner was allowed to stand, and then filtered using a filter paper in a state where the temperature was maintained at 30° C. After that, the filtrate was subjected to a defoaming treatment, and then subjected to casting in the solution film forming apparatus (not shown).

The dope at 30° C. was cast from a casting die to form a casting film. A blowing machine applied an air at 100° C. to the casting film immediately after the formation, and the dried casting film was peeled from a belt by a peeling roller. The casting film was peeled after 120 seconds after the formation. The solvent content of the casting film at a peeling position was 100% by mass. Peeling was performed with a tension of 150 N/m. This tension is a force per 1 m width of the casting film. The formed base material 11 was guided to a roller dryer, and dried while being handled in a state where a tension was applied in a longitudinal direction by a plurality of rollers. The tension applied in the longitudinal direction was 100 N/m. This tension is a force per 1 m width of the base material 11. The roller dryer had a first zone on the upstream side and a second zone on the downstream side. The first zone was set at 80° C., and the second zone was set at 120° C. The base material 11 was handled in the first zone for 5 minutes, and handled in the second zone for 10 minutes. The solvent content of the base material 11 wound around the winding core 38 by the winder was 0.3% by mass. This base material 11 was used in the examples.

The surface 11b of the base material 11 obtained above was saponified by the above-described laminated film forming apparatus 51. The base material 11 before the saponification treatment was unwound from the film roll and handled, and the saponification liquid was applied to the surface 11b before the saponification treatment by the application device provided in the handling path. The composition of the saponification liquid is as follows. In the following composition, % represents a percentage by mass. A laminated film material 50 in which the saponified layer 13 was formed with a thickness of 2 μm was obtained.

| | |
|---|---|
| Potassium hydroxide (KOH) | 3.3% |
| Isopropyl alcohol | 88% |
| Water | 3% |
| Propylene glycol | 5% |
| Surfactant | 0.04% |

### [Example 1] to [Example 24]

The laminated film 10 was manufactured using the laminated film manufacturing apparatus 30. As the base material 11, the base material 11 prepared according to the manufacture example was used. The type of the composition of the coating resin composition 47 that is the material of the resin layer 12 or the type of the film material that is the resin layer 12 is as follows. The type of the composition of the coating resin composition 47 represents A to F and H to J shown in the column “Resin layer Substance” in Table 1 or Table 2, and the type of the film material represents G shown in the column “Resin layer Substance” in Table 1 or Table 2.

Coating resin composition 47 for forming resin layer A:

Cellulose ester polymer and acrylic polymer parts by mass shown in
the column “Resin layer Amount” in Table 1 or Table 2

| | |
|---|---|
| Ultraviolet absorber | 15 parts by mass |
| 2-Butanone | 575 parts by mass |

Coating resin composition 47 for forming resin layer B:

| | |
|---|---|
| Cellulose ester polymer and acrylic | parts by mass shown in the column |
| polymer | “Resin layer Amount” in Table 1 |
| 2-Butanone | 295 parts by mass |
| 4-Methyl-2-pentanone | 295 parts by mass |

Coating resin composition 47 for forming resin layer D:

Cellulose ester polymer and polymethyl methacrylate
parts by mass shown in the column “Resin
layer Amount” in Table 1 or Table 2

| | |
|---|---|
| 2-Butanone | 295 parts by mass |
| 4-Methyl-2-pentanone | 295 parts by mass |

Coating resin composition 47 for forming resin layer H, I, or J:

Polyurethane parts by mass shown in the column
“Resin layer Amount” in Table 2

| | |
|---|---|
| 2-Butanone | 295 parts by mass |
| 4-Methyl-2-pentanone | 295 parts by mass |

In the coating resin composition 47 for forming the resin layer A, the cellulose ester polymer is cellulose acetate propionate (CAP-482-20, manufactured by Eastman Chemical Company), and is described as “CAP” in Table 1 or Table 2. The acrylic polymer is a copolymer of butyl methacrylate and methyl methacrylate (Dianal BR-113 (manufactured by Mitsubishi Rayon Co., Ltd.), and is described as “BR-113” in Table 1 or Table 2. The ultraviolet absorber is LA-46 (manufactured by ADEKA Corporation), and 2-butanone is a solvent. In the coating resin composition 47 for forming the resin layer B, the cellulose ester polymer is cellulose acetate butyrate (CAB-381-20, manufactured by Eastman Chemical Company), and is described as “CAB” in Table 1. The acrylic polymer is a copolymer of butyl methacrylate and methyl methacrylate (Dianal BR-77 (manufactured by Mitsubishi Rayon Co., Ltd.), and is described as “BR-77” in Table 1. 2-Butanone and 4-methyl-2-pentanone are solvents.

In the coating resin composition 47 for forming the resin layer D, the polymethyl methacrylate is Sumipex (registered trademark) MH-5 (manufactured by Sumitomo Chemical Co., Ltd.), and is described as “PMMA” in Table 1 or Table 2. In the coating resin composition 47 for forming the resin layer E, the polyurethane is obtained by using Pandex, Exp. GW-3670 (manufactured by DIC Corporation) and Pandex, Exp. HX-770 (manufactured by DIC Corporation) in a ratio of 100 parts by weight:7 parts by weight, and is described as “Polyurethane (1)” in Table 1. In the coating resin composition 47 for forming the resin layer F, the silicone resin is TSE-3033 (manufactured by Momentive Performance Materials Japan, Inc.), and is described as “Silicone” in Table 1. The resin layer G is a polyurethane film, and is a 40 μm film of Tough Grace, TG88-I (manufactured by Takeda Sangyo Co., Ltd.). The sticking between the base material 11 and the polyurethane film was performed using an acrylic pressure sensitive adhesive.

In the coating resin composition 47 for forming the resin layer H, I, or J, the polyurethane is obtained by replacing the two types of polyurethane of the resin layer E with the following polyurethane. The resin layer H is Elastollan NY1197A (manufactured by BASF), and is described as “Polyurethane (2)” in Table 2. The resin layer I is Elastollan C-90A (manufactured by BASF), and is described as “Polyurethane (3)”. The resin layer J is Elastollan 1164D (manufactured by BASF), and is described as “Polyurethane (4)”. The thickness of the formed resin layer is shown in the column “Thickness of resin layer” in Table 1 or Table 2.

In Example 21, the resin layer 12 was formed on the surface 11a opposite to the saponified layer 13 of the laminated film material 50 obtained by the manufacture example using the coating resin composition 47 for the resin layer D in the same manner as described above. In Table 1, “Present” was described in the column “Saponified layer”. Except for Example 21, no saponified layer was formed, and thus, in Table 1 or Table 2, “Absent” was described in the column “Saponified layer”.

The moisture permeability A10 of the obtained laminated film 10 was evaluated based on Japanese Industrial Standard JIS Z-0208, Condition B (40° C., RH of 90%). The moisture permeation resistance R12 per 1 μm of the thickness of the resin layer 12 was calculated from the moisture permeabilities A11 and A10 of the base material 11 and the laminated film 10. The thickness T10 of the obtained laminated film is shown in the column “Thickness of laminated film” in Table 1 or Table 2. The moisture permeation resistance R12 and the moisture permeabilities A11 and A10 are shown in Table 1 or Table 2.

The obtained laminated film 10 was evaluated. The obtained laminated film 10 was provided for the packaging material 14 (see FIG. 2). The capacity of the packaging bag 14 was about 1.5 L. 200 g of fresh broccoli was put into the packaging material 14, and the mouth of the bag was sealed with a tape. The sealed packaging bag 14 was put into a refrigerator (5° C. to 7° C., 23% to 74% RH), and the color of broccoli and the dew condensation inside the packaging bag 14 over time were observed. Reduction in the weight of the broccoli was measured by measuring the weight of the packaging bag 14. The package 28 sealed while containing the broccoli was allowed to stand in a refrigerator for 14 days. During 14 days, the temperature in the refrigerator changed in a range of 5° C. to 7° C., and the relative humidity changed in a range of 23% RH to 74% RH. The method and criteria for each evaluation are as follows. The evaluation results are shown in Table 1 or Table 2.

1. Dew Condensation

After the standing for 14 days, the package 28 was taken out of the refrigerator, and the degree of dew condensation inside the packaging bag 14 was visually observed. The evaluation criteria are as follows. A and B represent acceptable levels and C represents an unacceptable level. The evaluation results are shown in the column “Dew condensation” in Table 1 or Table 2.

A: Dew condensation in the packaging bag 14 is not confirmed.

B: Dew condensation in the packaging bag 14 is not confirmed, but slight fogging occurs.

C: Water droplets are confirmed in the packaging bag 14.

2. Color of Broccoli

The degree of discoloration was evaluated by visually observing flower buds of the broccoli and a stem cut after the standing. The evaluation criteria are as follows. 3 and 2 represent acceptable levels and 1 represents an unacceptable level. The evaluation results are shown in the column “Color” in Table 1 or Table 2.

3: There is no discoloration of the flower buds of the broccoli and the stem cut.

2: The flower buds of the broccoli are slightly yellowish. The stem cut is slightly discolored.

1: The flower buds of the broccoli are yellowish. The stem cut is brown.

3. Reduction in Weight of Broccoli

The mass of the broccoli after the standing was measured. The measured value is represented by MB (unit is g). Based on the mass (200 g) of the broccoli before being packaged with the packaging material 14, the ratio of the reduced mass was calculated as a percentage by the formula of {(200-MB)/200}×100. The results obtained are shown in the column “Reduction in weight” in Table 1 or Table 2.

4. Deformation and Wrinkles of Packaging Bag

After the standing for 14 days, the package 28 was taken out of a refrigerator, and deformation and wrinkles appearing as the deformation progressed in the packaging bag 14 were evaluated according to the following criteria. 3 and 2 represent acceptable levels and 1 represents an unacceptable level. The evaluation results are shown in the column “Deformation⋅wrinkles” in Table 1 or Table 2.

3: No deformation is seen in the packaging bag 14.

2: Deformation is seen in the packaging bag 14, but there is no problem in practical use.

1: Wrinkles and deformation are seen in the packaging bag 14.

5. Folding Property of Packaging Material

The laminated film 10 was cut into a sheet shape of 220 mm×300 mm, and the sheet was folded manually under the following conditions. After the folding, the folded portion was visually observed and evaluated as follows. The evaluation results are shown in the column “Folding of bag” in Table 1 or Table 2.

Conditions
Condition (1) The sheet is folded to such an extent that the mark remains.
Condition (2) Further, in this state, the folded portion is pressed and folded until the mark remains.

Evaluation
3: The folded portion is not cracked under any of Conditions (1) and (2).
2: Condition (1) has no crack. There is a crack under Condition (2).
1: Both Conditions (1) and (2) have cracks.

TABLE 1

| | First component | | Second component | | Thickness | Moisture permeability | | Resin layer | | |
|---|---|---|---|---|---|---|---|---|---|---|
| | | Acyl group | | Amount | of base | of base material | | | | Amount |
| | | substitution | | (parts by | material | 40° C. and RH of 90% | Saponified | | | (parts by |
| | Substance | degree | Substance | mass) | (μm) | (g/m² · day) | layer | Substance | | mass) |
| Example 1 | CA | 2.86 | A | 15 | 40 | 870 | Absent | A | CAP | 40 |
| | | | | | | | | | BR-113 | 60 |
| Example 2 | CA | 2.86 | A | 15 | 40 | 870 | Absent | A | CAP | 40 |
| | | | | | | | | | BR-113 | 60 |
| Example 3 | CA | 2.86 | A | 15 | 40 | 870 | Absent | A | CAP | 40 |
| | | | | | | | | | BR-113 | 60 |
| Example 4 | CA | 2.86 | A | 15 | 40 | 870 | Absent | A | CAP | 40 |
| | | | | | | | | | BR-113 | 60 |
| Example 5 | CA | 2.86 | A | 15 | 40 | 870 | Absent | B | CAB | 40 |
| | | | | | | | | | BR-77 | 60 |
| Example 6 | CA | 2.86 | A | 15 | 40 | 870 | Absent | B | CAB | 20 |
| | | | | | | | | | BR-77 | 80 |
| Example 7 | CA | 2.86 | A | 15 | 40 | 870 | Absent | D | CAB | 20 |
| | | | | | | | | | PMMA | 80 |
| Example 8 | CA | 2.86 | A | 15 | 40 | 870 | Absent | D | CAB | 20 |
| | | | | | | | | | PMMA | 80 |
| Example 9 | CA | 2.86 | A | 15 | 40 | 870 | Absent | D | CAB | 10 |
| | | | | | | | | | PMMA | 90 |
| Example 10 | CA | 2.86 | A | 15 | 40 | 870 | Absent | E | Polyurethane | 100 |
| | | | | | | | | | (1) | |
| Example 11 | CA | 2.86 | A | 15 | 40 | 870 | Absent | F | Silicone | 100 |
| Example 12 | CA | 2.86 | A | 15 | 40 | 870 | Absent | G | Polyurethane | — |
| | | | | | | | | | film | |
| Example 13 | CA | 2.86 | A | 15 | 20 | 1820 | Absent | A | CAP | 40 |
| | | | | | | | | | BR-113 | 60 |
| Example 14 | CA | 2.86 | A | 15 | 30 | 1180 | Absent | A | CAP | 40 |
| | | | | | | | | | BR-113 | 60 |
| Example 15 | CA | 2.86 | A | 15 | 80 | 450 | Absent | A | CAP | 40 |
| | | | | | | | | | BR-113 | 60 |

| | | Moisture | | | | | | | |
|---|---|---|---|---|---|---|---|---|---|
| | | permeation | | Moisture permeability | | | | | |
| | Thickness of | resistance | Thickness of | of laminated film | | Reduction in | | | |
| | resin layer | per 1 μm | laminated film | 40° C. and RH of 90% | Dew | weight | | Deformation • | Folding |
| | (μm) | ((m² · day/g)/μm | (μm) | (g/m² · day) | condensation | (%) | Color | wrinkles | of bag |
| Example 1 | 10 | 7.9 × 10⁻⁵ | 50 | 520 | 3 | 17 | 3 | 3 | 3 |
| Example 2 | 15 | 7.9 × 10⁻⁵ | 55 | 430 | 3 | 13 | 3 | 3 | 3 |
| Example 3 | 20 | 7.9 × 10⁻⁵ | 60 | 370 | 3 | 10 | 3 | 3 | 3 |
| Example 4 | 4 | 7.9 × 10⁻⁵ | 44 | 700 | 3 | 20 | 3 | 3 | 3 |
| Example 5 | 20 | 9.5 × 10⁻⁵ | 60 | 330 | 3 | 10 | 3 | 3 | 3 |
| Example 6 | 30 | 1.1 × 10⁻⁴ | 70 | 220 | 3 | 6 | 3 | 3 | 3 |
| Example 7 | 23 | 6.7 × 10⁻⁴ | 63 | 60 | 2 | 2 | 3 | 3 | 2 |
| Example 8 | 13 | 6.7 × 10⁻⁴ | 53 | 100 | 3 | 5 | 3 | 3 | 3 |
| Example 9 | 13 | 7.5 × 10⁻⁴ | 53 | 90 | 3 | 5 | 3 | 3 | 2 |
| Example 10 | 24 | 3.5 × 10⁻⁵ | 64 | 500 | 3 | 14 | 3 | 3 | 3 |
| Example 11 | 27 | 3.1 × 10⁻⁵ | 67 | 500 | 3 | 15 | 3 | 3 | 3 |
| Example 12 | 40 | 3.8 × 10⁻⁵ | 80 | 340 | 3 | 9 | 3 | 2 | 3 |
| Example 13 | 20 | 7.9 × 10⁻⁵ | 40 | 460 | 3 | 14 | 3 | 3 | 3 |
| Example 14 | 20 | 7.9 × 10⁻⁵ | 50 | 410 | 3 | 12 | 3 | 3 | 3 |
| Example 15 | 20 | 7.9 × 10⁻⁵ | 100 | 260 | 3 | 9 | 3 | 3 | 3 |

TABLE 2

| | First component | | Second component | | Thickness | Moisture permeability | | Resin layer | | |
|---|---|---|---|---|---|---|---|---|---|---|
| | | Acyl group | | Amount | of base | of base material | | | | Amount |
| | | substitution | | (parts by | material | 40° C. and RH of 90% | Saponified | | | (parts by |
| | Substance | degree | Substance | mass) | (μm) | (g/m² · day) | layer | Substance | | mass) |
| Example 16 | CA | 2.86 | B | 4 | 80 | 800 | Absent | A | CAP | 40 |
| | | | | | | | | | 3R-113 | 60 |
| Example 17 | CA | 2.86 | B | 4 | 100 | 640 | Absent | A | CAP | 40 |
| | | | | | | | | | 3R-113 | 60 |
| Example 18 | CA | 2.86 | A | 15 | 40 | 870 | Absent | H | Polyurethane | 100 |
| | | | | | | | | | (2) | |
| Example 19 | CA | 2.86 | A | 15 | 40 | 870 | Absent | I | Polyurethane | 100 |
| | | | | | | | | | (3) | |
| Example 20 | CA | 2.86 | A | 15 | 40 | 870 | Absent | J | Polyurethane | 100 |
| | | | | | | | | | (4) | |
| Example 21 | CA | 2.86 | A | 15 | 40 | 870 | Present | D | CAB | 20 |
| | | | | | | | | | PMMA | 80 |
| Example 22 | CA | 2.97 | A | 15 | 40 | 750 | Absent | A | CAP | 40 |
| | | | | | | | | | BR-113 | 60 |
| Example 23 | CA | 2.40 | A | 15 | 40 | 1020 | Absent | A | CAP | 40 |
| | | | | | | | | | BR-113 | 60 |
| Example 24 | CA | 2.00 | A | 15 | 40 | 1100 | Absent | A | CAP | 40 |
| | | | | | | | | | BR-113 | 60 |
| Comparative | CA | 2.86 | A | 15 | 40 | 50 | Absent | K | PMMA | — |
| Example 1 | | | | | | | | | | |
| Comparative | CA | 2.86 | A | 15 | 40 | 40 | Absent | L | PET | — |
| Example 2 | | | | | | | | | | |
| Comparative | CA | 2.86 | — | — | 60 | 261 | Absent | M | Acrylic HC | — |
| Example 3 | | | | | | | | | | |
| Comparative | CA | 2.86 | — | — | 60 | 66 | Absent | N | Layer of low | — |
| Example 4 | | | | | | | | | moisture | |
| | | | | | | | | | permeability | |

| | | | | | | | |
|---|---|---|---|---|---|---|---|
| Comparative | P-Plus | 40 | 20 | — | — | — | — |
| Example 5 | | | | | | | |
| Comparative | Polyamide film | 25 | 150 | — | — | — | — |
| Example 6 | | | | | | | |
| Comparative | No bag | — | — | — | — | — | — |
| Examnle 7 | | | | | | | |

| | | Moisture | | | | | | | |
|---|---|---|---|---|---|---|---|---|---|
| | | permeation | | Moisture permeability | | | | | |
| | Thickness of | resistance | Thickness of | of laminated film | | Reduction | | | |
| | resin layer | per 1 μm | laminated film | 40° C. and RH of 90% | Dew | in weight | | Deformation • | Folding |
| | (μm) | ((m² · day/g)/μm | (μm) | (g/m² · day) | condensation | (%) | Color | wrinkles | of bag |
| Example 16 | 20 | 7.9 × 10⁻⁵ | 100 | 350 | 3 | 10 | 3 | 3 | 3 |
| Example 17 | 20 | 7.9 × 10⁻⁵ | 120 | 320 | 3 | 8 | 3 | 3 | 2 |
| Example 18 | 60 | 3.0 × 10⁻⁵ | 100 | 340 | 3 | 13 | 3 | 2 | 3 |
| Example 19 | 36 | 7.1 × 10⁻⁵ | 76 | 270 | 3 | 6 | 3 | 3 | 3 |
| Example 20 | 37 | 2.4 × 10⁻⁵ | 77 | 100 | 3 | 4 | 3 | 3 | 3 |
| Example 21 | 23 | 6.7 × 10⁻⁴ | 63 | 65 | 3 | 4 | 3 | 3 | 2 |
| Example 22 | 20 | 7.9 × 10⁻⁵ | 60 | 340 | 3 | 9 | 3 | 3 | 3 |
| Example 23 | 20 | 7.9 × 10⁻⁵ | 60 | 395 | 3 | 10 | 3 | 3 | 3 |
| Example 24 | 20 | 7.9 × 10⁻⁵ | 60 | 405 | 3 | 11 | 3 | 2 | 3 |
| Comparative | 23 | 8.3 × l0⁻⁴ | 63 | 50 | 1 | 1 | 2 | 3 | 1 |
| Example 1 | | | | | | | | | |
| Comparative | 17 | 1.7 × 10⁻³ | 57 | 40 | 1 | 1 | 1 | 3 | 3 |
| Example 2 | | | | | | | | | |
| Comparative | 8 | 2.4 × 10⁻⁴ | 68 | 261 | 2 | 7 | 2 | 3 | 1 |
| Example 3 | | | | | | | | | |
| Comparative | 10 | 1.3 × 10⁻³ | 70 | 66 | 2 | 3 | 2 | 3 | 1 |
| Example 4 | | | | | | | | | |
| Comparative | — | — | — | — | 1 | 1 | 1 | 2 | 3 |
| Example 5 | | | | | | | | | |
| Comparative | — | — | — | — | 2 | 10 | 2 | 1 | 3 |
| Example 6 | | | | | | | | | |
| Comparative | — | — | — | — | — | 70 | 2 | — | — |
| Examnle 7 | | | | | | | | | |

### [Comparative Example 1] to [Comparative Example 7]

In Comparative Examples 1 and 2, the same materials as in the examples were used in the ratios shown in Table 2. In Comparative Examples 3 and 4, Fuji-Tac TD60 (manufactured by FUJIFILM Corporation) of a cellulose acetate film was used as the base material 11. The type of the composition of the coating resin composition 47 that is the material of the resin layer 12 is as follows. The type of the composition of the coating resin composition 47 represents K, M, or N shown in the column “Resin layer Substance” in Table 2, and the type of the film material represents L shown in the column “Resin layer Substance” in Table 2.

Coating resin composition 47 for forming resin layer K:

Polymethyl methacrylate parts by mass shown in the
column “Resin layer Amount” in Table 2

| | |
|---|---|
| 2-Butanone | 295 parts by mass |
| 4-Methyl-2-pentanone | 295 parts by mass |

Coating resin composition 47 for forming resin layer M:

Acrylic polymer parts by mass shown in the column
“Resin layer Amount” in Table 2

| | |
|---|---|
| 2-Butanone | 295 parts by mass |
| 4-Methyl-2-pentanone | 295 parts by mass |

Coating resin composition 47 for forming resin layer N:

Acrylic polymer parts by mass shown in the
column “Resin layer Amount in Table 2

| | |
|---|---|
| 2-Butanone | 295 parts by mass |
| 4-Methyl-2-pentanone | 295 parts by mass |

In the coating resin composition 47 for forming the resin layer K, the polymethyl methacrylate is Sumipex (registered trademark) MH-5 (manufactured by Sumitomo Chemical Co., Ltd.), and is described as “PMMA” in Table 2. The resin layer L was a PET film formed of polyethylene terephthalate (PET), and was Tetoron (registered trademark) G2 (manufactured by Teijin Film Solutions Ltd.) and had a thickness of 16 μm. In Table 2, it is described as “PET”. The sticking between the base material 11 and the PET film was performed using an acrylic pressure sensitive adhesive. In the coating resin composition 47 for forming the resin layer M, the acrylic polymer is pentaerythritol tetraacrylate (A-TMMT, manufactured by Shin-Nakamura Chemical Co., Ltd.), and this pentaerythritol tetraacrylate and Irgacure 907 as an initiator were cured by ultraviolet irradiation. In Table 2, it is described as “Acrylic HC”. In the coating resin composition 47 for forming the resin layer N, the acrylic polymer is tricyclodecane dimethanol diacrylate (A-DCP, manufactured by Shin-Nakamura Chemical Co., Ltd.), and this tricyclodecane dimethanol diacrylate, Pinecrystal KE604 (manufactured by Arakawa Chemical Industry Co., Ltd.), and Irgacure 907 as an initiator were cured by ultraviolet irradiation. In Table 2, it is described as “Layer of low moisture permeability”.

In Comparative Example 5, P-Plus (registered trademark) manufactured by Sumitomo Bakelite Co., Ltd. (with zipper, size: M, 295 mm×220 mm, thickness: 40 μm) was used. In Comparative Example 6, the packaging bag 14 using a polyamide film (size: 200 mm×300 mm, thickness: 25 (Kohbarrier ONY, manufactured by Kohjin Film & Chemicals Co., Ltd.) was used. In Comparative Example 7, broccoli was allowed to stand in a refrigerator in a state where the packaging bag 14 was not used, that is, in an unpackaged state. Other conditions are the same as those in the examples.

In Comparative Examples 1 to 7, the evaluation was performed in the same manner as in the examples. The evaluation results are shown in Table 2. Since the packaging bag 14 is not used in Comparative Example 7, “-” is described in the columns “First component”, “Second component”, “Thickness”, and “Moisture permeability” in Table 2. In addition, in other columns, in a case where the thickness and the like are not determined, “-” is described.

### EXPLANATION OF REFERENCES

10: laminated film
11: base material
11a: one surface
11b: the other surface
12: resin layer
T10: thickness of laminated film
T12: thickness of resin layer
13: saponified layer
T13: thickness of saponified layer
14: packaging material
H14: horizontal length
W14: vertical length
16: heat sealing part
18: opening
20: packaging material
W20: width of packaging material 20
22: margin
24: packaging material roll
W22: width of margin
W24: width of packing material roll
25: object to be packaged
26: folded portion
27: packaging material
W27: width of packaging material 27
D27: gusset width of packaging material 27
H27: height of packaging material 27
B27: bottom of packaging material 27
28: package
29: tape
30: laminated film manufacturing apparatus
31: feeder
32: resin layer forming unit
33: drying device
34: winder
37: base material
38: winding core
41: application device
42: infrared heater
44: roller
47: coating resin composition
48: coating film
50: laminated film
51: laminated film forming apparatus
52: saponification unit
54: laminated film material
56: winding core
58: saponification liquid
60: coating film
62: winding core

What is claimed is:

1. A packaging material comprising:
a laminated film,
wherein the laminated film contains a base material and a resin layer formed on one surface of the base material and has a moisture permeability at 40° C. and a relative humidity of 90% in a range of 60 g/m²·day or more and 700 g/m²·day or less,
the base material contains cellulose acylate, and
the resin layer contains any one of a composition including an acrylic resin and a cellulose derivative, a silicone elastomer, or a urethane elastomer.

2. The packaging material according to claim 1,
wherein the resin layer has a moisture permeation resistance per a thickness of 1 μm calculated from a moisture permeability at 40° C. and a relative humidity of 90% in a range of 3.0×10⁻⁵ (m²·day/g)/μm or more and 7.5×10⁻⁴ (m²·day/g)/μm or less.

3. The packaging material according to claim 1,
wherein the laminated film contains a saponified layer formed on the other surface of the base material opposite to the one surface, and
the saponified layer contains a saponified cellulose acylate.

4. The packaging material according to claim 1,
wherein the base material contains any one of an ester derivative of a monosaccharide, an ester derivative of a polysaccharide, an ester oligomer, or an acrylic polymer.

5. The packaging material according to claim 1,
wherein the laminated film has a thickness in a range of 10 μm to 120 μm.

6. The packaging material according to claim 1,
wherein the packaging material has a bag shape in which the resin layer is disposed outside.

7. The packaging material according to claim 1,
wherein the packaging material has a box shape in which the resin layer is disposed outside.

8. The packaging material according to claim 1,
wherein the packaging material has a cylindrical shape in which the resin layer is disposed outside.

9. The packaging material according to claim 1,
wherein the packaging material has a folded portion of the laminated film.

10. The packaging material according to claim 1,
wherein the packaging material packages a plant.

11. The packaging material according to claim 1,
wherein the packaging material packages fruits and vegetables.

12. The packaging material according to claim 1,
wherein the packaging material packages a food.

13. A method of using the packaging material according to claim 1, comprising:
packaging an object to be packaged in a sealed state with the packaging material.
